(19) United States
(12) Patent Application Publication
(10) Pub. No.: US 2023/0351383 A1
(43) Pub. Date: Nov. 2, 2023

(54) VALIDATION OF TRANSACTION AMOUNT

(71) Applicant: Intuit Inc., Mountain View, CA (US)

(72) Inventors: Natalie BAR ELIYAHU, Azor (IL); Yaaqov TAYEB, Tzur Hadasa (IL)

(73) Assignee: Intuit Inc., Mountain View, CA (US)

(21) Appl. No.: 17/730,984

(22) Filed: Apr. 27, 2022

(51) Int. Cl. G06Q 20/40; G06N 20/00

(52) U.S. Cl. CPC G06Q 20/401; G06N 20/00

(57) ABSTRACT

Systems and methods for validation of transaction amounts with a predictive model are disclosed. An example method may be performed by one or more processors of a system and include retrieving data indicating attributes for each of a plurality of transactions, assigning a label to each of the transactions based on whether an original amount entered changed, defining predictive features suggesting an extent to which final amounts stored for a particular set of similar transactions tend to vary, defining one or more interaction features suggesting a probability of a particular predictive feature value being generated for a transaction having particular attributes, generating, using a machine learning process, an anomaly scoring algorithm based on the predictive features and the one or more interaction features, and training, using the labeled transactions, a predictive model to predict, using the anomaly scoring algorithm, whether an amount entered for a given transaction will be changed.

### TECHNICAL FIELD

This disclosure relates generally to validation of transaction amounts, and specifically to validating transaction amounts using a predictive model and an anomaly scoring algorithm generated using a machine learning (ML) process.

### DESCRIPTION OF RELATED ART

Data management systems generally allow system users to perform a number of actions. For example, a computer-based data management system for assisting users with financial management may allow the users to enter information (e.g., manually via a user interface), such as a date of a financial transaction, an amount (or “value”) of a financial transaction, or the like. In some instances, an incorrect value for a transaction may be entered, such as an $840 transaction amount rather than an $8400 transaction amount.

Although many computer-based financial management systems allow users to correct mistakes, such as by modifying an incorrect value, users may not immediately become aware of incorrect values. An example user may enter an original amount (e.g., $840) for an income-based transaction having an actual amount (e.g., $8400) different than the entered amount. For this example, if the user enters the incorrect amount on the first day of the month (e.g., August 1) and reviews their monthly finances on the last day of the month (e.g., August 31), the user may feel confused about receiving a reconciliation error or as to why their monthly income seems lower than expected, and thus, may manually review their income transactions (e.g., for August) in an effort to find a mistake. Even if the user quickly identifies and corrects the mistake, the user may still feel irritated about wasting valuable time and resources. In some instances, the user may be unable to identify the mistake within a reasonable amount of time—such as by overlooking the incorrect amount or not remembering the transaction—and thus, may decide that the computer-based financial management system is faulty and abandon it.

Since users are generally more likely to recognize and correct a transaction error closer in time to when the error occurs, it is desirable for users to become aware of errors as soon as possible. Although some primitive systems have used basic predictive algorithms in an attempt to detect anomalies, the accuracy of such systems tends to be low, and thus users often remain unaware of mistakes or waste even more time and resources reviewing erroneous alerts.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for training a predictive model to validate a transaction amount. An example method may be performed by one or more processors of a validation system and include retrieving historical data indicating a number of attributes for each respective transaction of a plurality of transactions, assigning a label to each respective transaction of the plurality of transactions based on whether an original amount entered for the respective transaction was changed, defining a number of predictive features based on the attributes, the predictive features suggesting an extent to which final amounts stored for a particular set of similar transactions tend to vary, defining one or more interaction features based on the predictive features, the one or more interaction features suggesting a probability of a particular predictive feature value being generated for a transaction having particular attributes, generating, using a machine learning process, an anomaly scoring algorithm based on the predictive features and the one or more interaction features, and training, using the labeled transactions, a predictive model to predict, using the anomaly scoring algorithm, whether an amount originally entered for a given transaction will be changed.

In some aspects, assigning a first label to the respective transaction indicates that the original amount entered for the respective transaction is the same as the final amount stored for the respective transaction, and assigning a second label to the respective transaction indicates that the original amount entered for the respective transaction is different than the final amount stored for the respective transaction. In some other aspects, the plurality of transactions are retrieved from a transactions database, where each respective transaction is associated with one of a plurality of transaction types, one of a plurality of categories, and one of a plurality of users, where each of the plurality of users operates in one of a plurality of industries, and where the attributes include at least a first attribute indicating a date that the respective transaction occurred, a second attribute identifying a user associated with the respective transaction, a third attribute indicating a type of the respective transaction, a fourth attribute indicating a category assigned to the respective transaction, a fifth attribute indicating an original amount entered for the respective transaction, and a sixth attribute indicating a final amount stored for the respective transaction.

In some implementations, each respective transaction is associated with one of a plurality of transaction types, where the attributes indicate at least a date that the respective transaction occurred, a transaction type of the respective transaction, an original amount entered for the respective transaction, and a final amount stored for the respective transaction, where the predictive features includes at least a type abnormality feature suggesting an extent to which final amounts stored for transactions of a specified transaction type tend to vary during a specified time period, and where defining the type abnormality feature includes grouping the plurality of transactions into sets of same-type transactions based on the historical data, where each transaction of each set of same-type transactions occurred during a same time period and is of a same transaction type, determining a centrality point of the final amounts stored for each set of same-type transactions, determining, for each set of same-type transactions, a measure of variability between the centrality point and each final amount stored for the corresponding set of same-type transactions, and determining, based on the corresponding measures of variability, a central tendency of variability among the final amounts stored for each set of same-type transactions, where determining the central tendency of variability includes selectively applying a number of type seasonality weights to the corresponding measures of variability based on whether the associated transaction occurred before or after a particular date, during a particular range of dates, or within a particular pattern deemed relevant to the corresponding transaction type.

In some other implementations, each respective transaction is associated with one of a plurality of users, where each of the plurality of users operates in one of a plurality of industries, and where the attributes indicate at least a date that the respective transaction occurred, a user associated with the respective transaction, an original amount entered for the respective transaction, and a final amount stored for the respective transaction, where the predictive features includes at least an industry abnormality feature suggesting an extent to which final amounts stored for transactions associated with users operating in a specified industry tend to vary during a specified time period, and where defining the industry abnormality feature includes grouping the plurality of transactions into sets of same-industry transactions based on the historical data, where each transaction of each set of same-industry transactions occurred during a same time period and is associated with a user operating in a same industry, determining a centrality point of the final amounts stored for each set of same-industry transactions, determining, for each set of same-industry transactions, a measure of variability between the centrality point and each final amount stored for the corresponding set of same-industry transactions, and determining, based on the corresponding measures of variability, a central tendency of variability among the final amounts stored for each set of same-industry transactions, where determining the central tendency of variability includes selectively applying a number of industry seasonality weights to the corresponding measures of variability based on whether the associated transaction occurred before or after a particular date, during a particular range of dates, or within a particular pattern deemed relevant to the corresponding industry.

In some implementations, each respective transaction is associated with one of a plurality of categories and one of a plurality of users, and the attributes indicate at least a date that the respective transaction occurred, a user associated with the respective transaction, a category assigned to the respective transaction, an original amount entered for the respective transaction, and a final amount stored for the respective transaction, where the predictive features include at least a per-user category abnormality feature suggesting, for each respective user, an extent to which final amounts stored for transactions assigned a specified category tend to vary for the respective user during a specified time period, and where defining the per-user category abnormality feature includes grouping, for each respective user, the plurality of transactions into sets of same-category transactions based on the historical data, where each transaction of each set of same-category transactions is associated with a same respective user, occurred during a same time period, and is assigned a same category, determining, for each respective same user, a centrality point of the final amounts stored for each set of same-category transactions associated with the respective same user, determining, for each set of same-category transactions, a measure of variability between the centrality point and each final amount stored for the corresponding set of same-category transactions, and determining, based on the corresponding measures of variability and for each respective same user, a central tendency of variability among the final amounts stored for each set of same-category transactions associated with the respective same user, where determining the central tendency of variability includes selectively applying a number of user seasonality weights to the corresponding measures of variability based on whether the associated transaction occurred before or after a particular date, during a particular range of dates, or within a particular pattern deemed relevant to transactions associated with the respective same user and the respective same category. In some instances, the one or more interaction features include at least a global category interaction feature suggesting a probability of a category abnormality feature value being generated for a transaction associated with a given user, occurring on a given date, and assigned a given category.

In some aspects, the anomaly scoring algorithm incorporates at least one of a type abnormality feature suggesting an extent to which final amounts stored for transactions of a specified transaction type tend to vary over time, an industry abnormality feature suggesting an extent to which final amounts stored for transactions associated with users operating in a specified industry tend to vary over time, a user category abnormality feature suggesting, for each respective user of a plurality of users, an extent to which final amounts stored for transactions assigned a specified category tend to vary over time for the respective user, and a global category interaction feature suggesting, for each respective user, an extent to which the user category abnormality feature tends to vary over time for transactions associated with the respective user and assigned a given category.

In some implementations, the method may further include determining, using validation data associated with prelabeled transactions, an accuracy at which the predictive model can determine whether amounts originally entered for the prelabeled transactions were changed, training, using additional historical data associated with additional transactions, the predictive model to more accurately predict, using the anomaly scoring algorithm, whether an amount originally entered for a given transaction will be changed, and iteratively validating and training the predictive model until the determined accuracy is greater than a value.

Another innovative aspect of the subject matter described in this disclosure can be implemented in a system for training a predictive model to validate a transaction amount. An example system may include one or more processors and a memory storing instructions for execution by the one or more processors. Execution of the instructions may cause the system to perform operations including retrieving historical data indicating a number of attributes for each respective transaction of a plurality of transactions, assigning a label to each respective transaction of the plurality of transactions based on whether an original amount entered for the respective transaction was changed, defining a number of predictive features based on the attributes, the predictive features suggesting an extent to which final amounts stored for a particular set of similar transactions tend to vary, defining one or more interaction features based on the predictive features, the one or more interaction features suggesting a probability of a particular predictive feature value being generated for a transaction having particular attributes, generating, using a machine learning process, an anomaly scoring algorithm based on the predictive features and the one or more interaction features, and training, using the labeled transactions, a predictive model to predict, using the anomaly scoring algorithm, whether an amount originally entered for a given transaction will be changed.

In some aspects, assigning a first label to the respective transaction indicates that the original amount entered for the respective transaction is the same as the final amount stored for the respective transaction, and assigning a second label to the respective transaction indicates that the original amount entered for the respective transaction is different than the final amount stored for the respective transaction. In some other aspects, the plurality of transactions are retrieved from a transactions database, where each respective transaction is associated with one of a plurality of transaction types, one of a plurality of categories, and one of a plurality of users, where each of the plurality of users operates in one of a plurality of industries, and where the attributes include at least a first attribute indicating a date that the respective transaction occurred, a second attribute identifying a user associated with the respective transaction, a third attribute indicating a type of the respective transaction, a fourth attribute indicating a category assigned to the respective transaction, a fifth attribute indicating an original amount entered for the respective transaction, and a sixth attribute indicating a final amount stored for the respective transaction.

In some implementations, each respective transaction is associated with one of a plurality of transaction types, where the attributes indicate at least a date that the respective transaction occurred, a transaction type of the respective transaction, an original amount entered for the respective transaction, and a final amount stored for the respective transaction, where the predictive features include at least a type abnormality feature suggesting an extent to which final amounts stored for transactions of a specified transaction type tend to vary during a specified time period, and where defining the type abnormality feature includes grouping the plurality of transactions into sets of same-type transactions based on the historical data, where each transaction of each set of same-type transactions occurred during a same time period and is of a same transaction type, determining a centrality point of the final amounts stored for each set of same-type transactions, determining, for each set of same-type transactions, a measure of variability between the centrality point and each final amount stored for the corresponding set of same-type transactions, and determining, based on the corresponding measures of variability, a central tendency of variability among the final amounts stored for each set of same-type transactions, where determining the central tendency of variability includes selectively applying a number of type seasonality weights to the corresponding measures of variability based on whether the associated transaction occurred before or after a particular date, during a particular range of dates, or within a particular pattern deemed relevant to the corresponding transaction type.

In some other implementations, each respective transaction is associated with one of a plurality of users, where each of the plurality of users operates in one of a plurality of industries, and where the attributes indicate at least a date that the respective transaction occurred, a user associated with the respective transaction, an original amount entered for the respective transaction, and a final amount stored for the respective transaction, where the predictive features include at least an industry abnormality feature suggesting an extent to which final amounts stored for transactions associated with users operating in a specified industry tend to vary during a specified time period, and where defining the industry abnormality feature includes grouping the plurality of transactions into sets of same-industry transactions based on the historical data, where each transaction of each set of same-industry transactions occurred during a same time period and is associated with a user operating in a same industry, determining a centrality point of the final amounts stored for each set of same-industry transactions, determining, for each set of same-industry transactions, a measure of variability between the centrality point and each final amount stored for the corresponding set of same-industry transactions, and determining, based on the corresponding measures of variability, a central tendency of variability among the final amounts stored for each set of same-industry transactions, where determining the central tendency of variability includes selectively applying a number of industry seasonality weights to the corresponding measures of variability based on whether the associated transaction occurred before or after a particular date, during a particular range of dates, or within a particular pattern deemed relevant to the corresponding industry.

In some implementations, each respective transaction is associated with one of a plurality of categories and one of a plurality of users, and where the attributes indicate at least a date that the respective transaction occurred, a user associated with the respective transaction, a category assigned to the respective transaction, an original amount entered for the respective transaction, and a final amount stored for the respective transaction, where the predictive features include at least a per-user category abnormality feature suggesting, for each respective user, an extent to which final amounts stored for transactions assigned a specified category tend to vary for the respective user during a specified time period, and where defining the per-user category abnormality feature includes grouping, for each respective user, the plurality of transactions into sets of same-category transactions based on the historical data, where each transaction of each set of same-category transactions is associated with a same respective user, occurred during a same time period, and is assigned a same category, determining, for each respective same user, a centrality point of the final amounts stored for each set of same-category transactions associated with the respective same user, determining, for each set of same-category transactions, a measure of variability between the centrality point and each final amount stored for the corresponding set of same-category transactions, and determining, based on the corresponding measures of variability and for each respective same user, a central tendency of variability among the final amounts stored for each set of same-category transactions associated with the respective same user, where determining the central tendency of variability includes selectively applying a number of user seasonality weights to the corresponding measures of variability based on whether the associated transaction occurred before or after a particular date, during a particular range of dates, or within a particular pattern deemed relevant to transactions associated with the respective same user and the respective same category. In some instances, the one or more interaction features include at least a global category interaction feature suggesting a probability of a category abnormality feature value being generated for a transaction associated with a given user, occurring on a given date, and assigned a given category.

In some aspects, the anomaly scoring algorithm incorporates at least one of a type abnormality feature suggesting an extent to which final amounts stored for transactions of a specified transaction type tend to vary over time, an industry abnormality feature suggesting an extent to which final amounts stored for transactions associated with users operating in a specified industry tend to vary over time, a user category abnormality feature suggesting, for each respective user of a plurality of users, an extent to which final amounts stored for transactions assigned a specified category tend to vary over time for the respective user, and a global category interaction feature suggesting, for each respective user, an extent to which the user category abnormality feature tends to vary over time for transactions associated with the respective user and assigned a given category.

In some implementations, execution of the instructions may cause the system to perform operations further including determining, using validation data associated with prelabeled transactions, an accuracy at which the predictive model can determine whether amounts originally entered for the prelabeled transactions were changed, training, using additional historical data associated with additional transactions, the predictive model to more accurately predict, using the anomaly scoring algorithm, whether an amount originally entered for a given transaction will be changed, and iteratively validating and training the predictive model until the determined accuracy is greater than a value.

Another innovative aspect of the subject matter described in this disclosure can be implemented as a non-transitory computer-readable medium storing instructions that, when executed by one or more processors of a system for training a predictive model to validate a transaction amount, cause the system to perform operations. Example operations may include retrieving historical data indicating a number of attributes for each respective transaction of a plurality of transactions, assigning a label to each respective transaction of the plurality of transactions based on whether an original amount entered for the respective transaction was changed, defining a number of predictive features based on the attributes, the predictive features suggesting an extent to which final amounts stored for a particular set of similar transactions tend to vary, defining one or more interaction features based on the predictive features, the one or more interaction features suggesting a probability of a particular predictive feature value being generated for a transaction having particular attributes, generating, using a machine learning process, an anomaly scoring algorithm based on the predictive features and the one or more interaction features, and training, using the labeled transactions, a predictive model to predict, using the anomaly scoring algorithm, whether an amount originally entered for a given transaction will be changed.

Another innovative aspect of the subject matter described in this disclosure can be implemented as a method for validating a transaction amount. An example method may be performed by one or more processors of a validation system and include generating a number of feature values for a current transaction, the feature values suggesting a probability of an original amount being entered for the current transaction based on attributes of the current transaction, generating one or more interaction feature values for the current transaction, the one or more interaction feature values suggesting a probability of at least one of the feature values being generated given the current transaction's attributes, predicting, using a predictive model and an anomaly scoring algorithm generated using a machine learning process, a likelihood that the original amount entered for the current transaction will be changed based on the feature values and the one or more interaction feature values, and classifying the original amount as normal or anomalous based on the predicted likelihood.

In some aspects, the original amount is classified as anomalous if the predicted likelihood is greater than a threshold, and the original amount is classified as normal if the predicted likelihood is not greater than the threshold, where the method may further include detecting, in real-time, the original amount being entered for the current transaction via a user interface, and selectively flagging, in real-time, the current transaction based on whether the original amount is classified as normal or anomalous. In some instances, the selective flagging includes, responsive to classifying the original amount as anomalous, at least one of notifying, via the user interface, a user associated with the current transaction that the original amount is likely inaccurate, generating a proposed value to replace the original amount, or requesting, via the user interface, that the user enter a replacement amount, and responsive to classifying the original amount as normal, refraining from flagging the current transaction.

In some implementations, the current transaction's attributes indicate at least a specified date on which the current transaction occurred and a specified type of the current transaction, where the feature values include at least a type abnormality score suggesting a probability of the original amount being entered for a transaction of the specified type given the specified date, and where generating the type abnormality score includes identifying, among a plurality of transactions in a transactions database, a set of same-type transactions relevant to the current transaction based on the specified date and the specified type, determining a current measure of variability between the original amount entered for the current transaction and a centrality point of final amounts stored for the relevant set of same-type transactions, and generating, based on a type abnormality feature of the anomaly scoring algorithm, the type abnormality score based on a difference between the current measure of variability and a central tendency of variability determined for the relevant set of same-type transactions.

In some other implementations, the current transaction's attributes indicate at least a specified date on which the current transaction occurred and a specified user associated with the current transaction and operating in a specified industry, where the feature values include at least an industry abnormality score suggesting a probability of the original amount being entered for a transaction associated with a user operating in the specified industry given the specified date, and where generating the industry abnormality score includes identifying, among a plurality of transactions in a transactions database, a set of same-industry transactions relevant to the current transaction based on the specified date and the specified industry, determining a current measure of variability between the original amount entered for the current transaction and a centrality point of final amounts stored for the relevant set of same-industry transactions, and generating, based on an industry abnormality feature of the anomaly scoring algorithm, the industry abnormality score based on a difference between the current measure of variability and a central tendency of variability determined for the relevant set of same-industry transactions.

In some implementations, the current transaction's attributes indicate at least a specified date on which the current transaction occurred, a specified category assigned to the current transaction, and a specified user associated with the current transaction, where the feature values include at least a user category abnormality score suggesting a probability of the original amount being entered for a transaction associated with the specified user and assigned the specified category given the specified date, and where generating the user category abnormality score includes identifying, among a plurality of transactions in a transactions database, a user-relevant set of same-category transactions based on the specified date, where each transaction of the user-relevant set of same-category transactions is associated with the specified user and is assigned the specified category, determining a user centrality point of final amounts stored for the user-relevant set of same-category transactions, determining a historical measure of variability between the user centrality point and each of the final amounts stored for the user-relevant set of same-category transactions, determining a central tendency of variability among the final amounts stored for the user-relevant set of same-category transactions based on the historical measures of variability, where the determining includes selectively applying a number of specified user seasonality weights to the historical measures of variability based on whether the specified date occurred before or after a particular date, during a particular range of dates, or within a particular pattern deemed relevant to transactions associated with the specified user and the specified category, determining a current measure of variability between the original amount entered for the current transaction and the user centrality point, and generating, based on a per-user category abnormality feature of the anomaly scoring algorithm, the user category abnormality score based on a difference between the current measure of variability and the central tendency of variability. In some instances, the one or more interaction feature values include at least a category interaction abnormality score suggesting a probability of the user category abnormality score being generated for a transaction assigned the specified category given the specified date, and where generating the category interaction abnormality score includes identifying, among the plurality of transactions in the transactions database, one or more global sets of same-category transactions relevant to the current transaction based on the specified category and the specified date, determining a global centrality point of a number of central tendencies of variability determined for the identified global sets of same-category transactions, determining, for each respective central tendency of variability, a measure of variability between the respective central tendency of variability and the global centrality point, determining, based on the corresponding measures of variability, a global central tendency of variability among the central tendencies of variability determined for the identified global sets of same-category transactions, and generating, based on a global category interaction feature of the anomaly scoring algorithm, the category interaction abnormality score based on a difference between the global central tendency of variability and the current measure of variability associated with the user category abnormality score.

In some aspects, the predicted likelihood is based on a probability of the original amount being entered for the current transaction given a type of the current transaction, a category assigned to the current transaction, a user associated with the current transaction, an industry in which the associated user operates, and a date on which the current transaction occurred.

In some implementations, the method may further include determining whether a final amount stored for the current transaction is different than the original amount, annotating the current transaction based on the determining and the classifying of the original amount, where the current transaction is annotated as false-negative responsive to the original amount being classified as normal and the final amount being different than the original amount, false-positive responsive to the original amount being classified as anomalous and the final amount being the same as the original amount, true-negative responsive to the original amount being classified as normal and the final amount being the same as the original amount, or true-positive responsive to the original amount being classified as anomalous and the final amount being different than the original amount, and selectively providing the current transaction to at least one of a training engine or an adaptation engine based on the annotating.

Another innovative aspect of the subject matter described in this disclosure can be implemented in a system for validating a transaction amount. An example system may include one or more processors and a memory storing instructions for execution by the one or more processors. Execution of the instructions may cause the system to perform operations including generating a number of feature values for a current transaction, the feature values suggesting a probability of an original amount being entered for the current transaction based on attributes of the current transaction, generating one or more interaction feature values for the current transaction, the one or more interaction feature values suggesting a probability of at least one of the feature values being generated given the current transaction's attributes, predicting, using a predictive model and an anomaly scoring algorithm generated using a machine learning process, a likelihood that the original amount will be changed based on the feature values and the one or more interaction feature values, and classifying the original amount as normal or anomalous based on the predicted likelihood.

In some aspects, the original amount is classified as anomalous if the predicted likelihood is greater than a threshold, and the original amount is classified as normal if the predicted likelihood is not greater than the threshold, where execution of the instructions may cause the system to perform operations further including detecting, in real-time, the original amount being entered for the current transaction via a user interface, and selectively flagging, in real-time, the current transaction based on whether the original amount is classified as normal or anomalous. In some instances, the selective flagging includes, responsive to classifying the original amount as anomalous, at least one of notifying, via the user interface, a user associated with the current transaction that the original amount is likely inaccurate, generating a proposed value to replace the original amount, or requesting, via the user interface, that the user enter a replacement amount, and responsive to classifying the original amount as normal, refraining from flagging the current transaction.

In some implementations, the current transaction's attributes indicate at least a specified date on which the current transaction occurred and a specified type of the current transaction, where the feature values include at least a type abnormality score suggesting a probability of the original amount being entered for a transaction of the specified type given the specified date, and where generating the type abnormality score includes identifying, among a plurality of transactions in a transactions database, a set of same-type transactions relevant to the current transaction based on the specified date and the specified type, determining a current measure of variability between the original amount entered for the current transaction and a centrality point of final amounts stored for the relevant set of same-type transactions, and generating, based on a type abnormality feature of the anomaly scoring algorithm, the type abnormality score based on a difference between the current measure of variability and a central tendency of variability determined for the relevant set of same-type transactions.

In some other implementations, the current transaction's attributes indicate at least a specified date on which the current transaction occurred and a specified user associated with the current transaction and operating in a specified industry, where the feature values include at least an industry abnormality score suggesting a probability of the original amount being entered for a transaction associated with a user operating in the specified industry given the specified date, and where generating the industry abnormality score includes identifying, among a plurality of transactions in a transactions database, a set of same-industry transactions relevant to the current transaction based on the specified date and the specified industry, determining a current measure of variability between the original amount entered for the current transaction and a centrality point of final amounts stored for the relevant set of same-industry transactions, and generating, based on an industry abnormality feature of the anomaly scoring algorithm, the industry abnormality score based on a difference between the current measure of variability and a central tendency of variability determined for the relevant set of same-industry transactions.

In some implementations, the current transaction's attributes indicate at least a specified date on which the current transaction occurred, a specified category assigned to the current transaction, and a specified user associated with the current transaction, where the feature values include at least a user category abnormality score suggesting a probability of the original amount being entered for a transaction associated with the specified user and assigned the specified category given the specified date, and where generating the user category abnormality score includes identifying, among a plurality of transactions in a transactions database, a user-relevant set of same-category transactions based on the specified date, where each transaction of the user-relevant set of same-category transactions is associated with the specified user and is assigned the specified category, determining a user centrality point of final amounts stored for the user-relevant set of same-category transactions, determining a historical measure of variability between the user centrality point and each of the final amounts stored for the user-relevant set of same-category transactions, determining a central tendency of variability among the final amounts stored for the user-relevant set of same-category transactions based on the historical measures of variability, where the determining includes selectively applying a number of specified user seasonality weights to the historical measures of variability based on whether the specified date occurred before or after a particular date, during a particular range of dates, or within a particular pattern deemed relevant to transactions associated with the specified user and the specified category, determining a current measure of variability between the original amount entered for the current transaction and the user centrality point, and generating, based on a per-user category abnormality feature of the anomaly scoring algorithm, the user category abnormality score based on a difference between the current measure of variability and the central tendency of variability. In some instances, the one or more interaction feature values include at least a category interaction abnormality score suggesting a probability of the user category abnormality score being generated for a transaction assigned the specified category given the specified date, and where generating the category interaction abnormality score includes identifying, among the plurality of transactions in the transactions database, one or more global sets of same-category transactions relevant to the current transaction based on the specified category and the specified date, determining a global centrality point of a number of central tendencies of variability determined for the identified global sets of same-category transactions, determining, for each respective central tendency of variability, a measure of variability between the respective central tendency of variability and the global centrality point, determining, based on the corresponding measures of variability, a global central tendency of variability among the central tendencies of variability determined for the identified global sets of same-category transactions, and generating, based on a global category interaction feature of the anomaly scoring algorithm, the category interaction abnormality score based on a difference between the global central tendency of variability and the current measure of variability associated with the user category abnormality score.

In some aspects, the predicted likelihood is based on a probability of the original amount being entered for the current transaction given a type of the current transaction, a category assigned to the current transaction, a user associated with the current transaction, an industry in which the associated user operates, and a date on which the current transaction occurred.

In some implementations, execution of the instructions may cause the system to perform operations further including determining whether a final amount stored for the current transaction is different than the original amount, annotating the current transaction based on the determining and the classifying of the original amount, where the current transaction is annotated as false-negative responsive to the original amount being classified as normal and the final amount being different than the original amount, false-positive responsive to the original amount being classified as anomalous and the final amount being the same as the original amount, true-negative responsive to the original amount being classified as normal and the final amount being the same as the original amount, or true-positive responsive to the original amount being classified as anomalous and the final amount being different than the original amount, and selectively providing the current transaction to at least one of a training engine or an adaptation engine based on the annotating.

Another innovative aspect of the subject matter described in this disclosure can be implemented as a non-transitory computer-readable medium storing instructions that, when executed by one or more processors of a system for validating a transaction amount, cause the system to perform operations. Example operations may include generating a number of feature values for a current transaction, the feature values suggesting a probability of an original amount being entered for the current transaction based on attributes of the current transaction, generating one or more interaction feature values for the current transaction, the one or more interaction feature values suggesting a probability of at least one of the feature values being generated given the current transaction's attributes, predicting, using a predictive model and an anomaly scoring algorithm generated using a machine learning process, a likelihood that the original amount will be changed based on the feature values and the one or more interaction feature values, and classifying the original amount as normal or anomalous based on the predicted likelihood.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a validation system, according to some implementations.

FIG. 2 shows a high-level overview of an example process flow that may be employed by a validation system, according to some implementations.

FIG. 3 shows a high-level overview of an example process flow that may be employed by a validation system, according to some implementations.

FIG. 4 shows an illustrative flowchart depicting an example operation for training a predictive model to validate a transaction amount, according to some implementations.

FIG. 5 shows an illustrative flowchart depicting an example operation for validating a transaction amount, according to some implementations.

Like numbers reference like elements throughout the drawings and specification.

### DETAILED DESCRIPTION

As described above, it is desirable for computer-based data management systems (such as financial management systems) to identify errors (such as incorrectly entered transaction amounts) as accurately and as soon as possible, such that users may feel confident that the computer-based data management system is reliable, relieved that their information is in-order, and motivated to continue using the system. Although some systems have tried to use predictive algorithms to alert users about potential mistakes, the accuracy of such systems tends to be low, for example, because the predictive algorithms are based on unsupervised anomaly detection techniques that rely on flat distances between current values and basic statistical measures of previous values. For example, some primitive systems may compare a distance between a current value and a predetermined statistical value (e.g., such as an average of historical values), and determine that the current value is an anomaly if the distance between the current value and the historical average is above some static threshold. Examples include unsupervised Mahalanobis distance anomaly detectors, isolation forest models, auto-encoders, and the like.

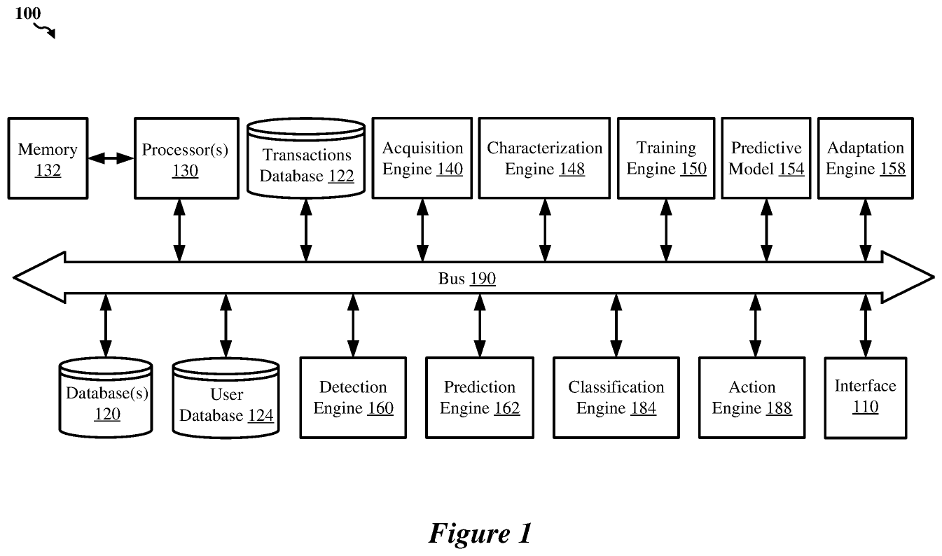

Implementations of the subject matter described in this disclosure may be used in training a predictive model to validate a transaction amount and/or in using a trained predictive model to validate a transaction amount. In some implementations, the predictive model uses an anomaly scoring algorithm generated using a machine learning process and incorporates a number of predictive input features and one or more interaction input features such that a “first-layer” analysis of transactions (e.g., such as for a particular user) is compared with a “second-layer” analysis of global transactions (e.g., such as for a specified portion of, including all, users), as further described in connection with FIG. 1. In some implementations, the predictive model is trained in an at least semi-supervised manner using transactions labeled based on whether an original amount entered for the labeled transaction is different than a final amount stored for the labeled transaction, and the machine learning process determines a set of statistically most optimal weighting factors for each input feature incorporated into the anomaly scoring algorithm, such as based on a number of attributes of the transactions and/or users (e.g., a type of the transaction, a category assigned to the transaction, a user associated with the transaction, an industry in which the associated user operates, a date on which the transaction occurred, and/or other appropriate attributes). In various implementations, the predictive model, in conjunction with the anomaly scoring algorithm, is trained and/or used in (at least near) real-time to validate a transaction amount—that is, to predict a likelihood that an original amount entered for a given transaction will be changed, or is otherwise an anomaly, based on the given transaction's attributes. In some implementations, in response to predicting that an entered transaction amount will be changed, the system may execute one or more actions to flag, or otherwise correct, the anomalous amount.

In these and other manners, implementations of the subject matter described in this disclosure may provide one or more benefits such as training a predictive model to validate a transaction amount, labeling transactions, defining input features—including one or more interaction features—for an anomaly scoring algorithm, generating the anomaly scoring algorithm using a machine learning process, and/or training a predictive model to predict whether an original amount entered for a given transaction is an anomaly using the anomaly scoring algorithm. At least some of such implementations may also provide one or more benefits such as defining, for the anomaly scoring algorithm, at least one of a type abnormality feature, an industry abnormality feature, a category abnormality feature, or one or more interaction features based on said abnormality features, determining an accuracy of the predictive model, and/or iteratively validating and/or training the predictive model until the accuracy is at a suitable level.

In addition, or in the alternative, implementations of the subject matter described in this disclosure may provide one or more benefits such as validating a transaction amount (e.g., in real-time), generating a number of feature values—including one or more interaction feature values—for a current transaction, predicting a likelihood that an originally amount entered for a transaction is an anomaly based on a trained predictive model and an anomaly scoring algorithm generated using a machine learning process, and/or classifying the original amount as normal or anomalous based on the predicted likelihood. At least some of such implementations may also provide one or more benefits such as detecting an original amount being entered (e.g., via a user interface) for a current transaction, selectively performing one or more actions based on whether the original amount is classified as normal or anomalous, generating, for the original amount, at least one of a type abnormality score, an industry abnormality score, a category abnormality score, and one or more interaction scores based on said abnormality scores, annotating a current transaction based on determining whether a final amount stored is different than an original amount entered, and/or selectively providing a current transaction to one or more appropriate components for further processing.

Furthermore, implementations of the subject matter described in this disclosure may provide one or more benefits such as identifying incorrectly entered amounts as soon as possible (e.g., immediately) and as accurately as possible, providing multi-layer, at least semi-supervised anomaly detection, improving user experience, enhancing workflow, reducing system errors, reducing reconciliation errors, reducing user time and effort, reducing system processing and memory resources, increasing user satisfaction and retention, and so on.

For purposes of discussion herein, a “system” may refer to any appropriate system for training a predictive model to validate a transaction amount and/or validating a transaction amount, such as like the systems described below in connection with FIGS. 1-3. For purposes of discussion herein, a “user” or “system user” may refer to a user of any one or more of the systems, and a user may “use the system” by, for example, entering a transaction amount. A system user may affect system changes, issue system commands, or access system information via one or more appropriate sources, such as a device of the user (e.g., a smartphone, a tablet, a personal computer (PC), or a different suitable electronic device), a device communicatively coupled to and/or associated with the system, a data store (e.g., a memory, a database, an index, or the like), an interface (e.g., a user interface), an output of an algorithm, one or more computer-based modules or runtime engines, or any other suitable source. As used herein, a “current user” entering an amount for a “current transaction” may refer to a user entering an amount for a transaction in real-time.

For purposes of discussion herein, a “transaction” may generally refer to an agreement, or communication, between an associated user and at least one other party, such as to exchange goods, services, assets, or the like, for payment (e.g., such as a particular amount of money), such that at least some portion of the finances of the user are (at least intended to be) transferred to the other party (e.g., such as an expense-type transaction) and/or such that at least some portion of the finances of the other party are (at least intended to be) transferred to the user (e.g., such as an income-type transaction). For purposes of discussion herein, a “historical transaction” may refer to a transaction that occurred during a time period relevant to training the predictive model to validate a transaction amount (such as described with respect to FIGS. 1, 2, and 4), and a “current transaction” may refer to a transaction that occurred during the time period relevant to using a trained predictive model to validate a transaction amount (such as described with respect to FIGS. 1, 3, and 5). For purposes of discussion herein, a date on which a transaction “occurred” may refer to a date on which the agreement or communication was actually executed or happened, and may not be the same date that an amount of the transaction is entered.

For purposes of discussion herein, an “attribute” of a transaction or user may refer to any appropriate characteristic of the transaction or user, including but not limited to a date that the transaction occurred, a user associated with the transaction, a type of the transaction, a category assigned to the transaction, an original amount entered for the transaction, a final amount stored for the transaction, an industry in which the associated user operates, or any number of other appropriate attributes (or “characteristics”) of a transaction or user deemed relevant to validating transaction amounts based on a predictive model and an anomaly scoring algorithm generated using a machine learning process.

For purposes of discussion herein, an “industry” in which a user operates may refer to a classification of a type of organization grouped based on similar processes, products, behavior, or the like. Non-limiting examples of an industry may include the marketing industry, the transportation industry, the plant industry, the dental industry, the non-profit industry, the educational industry, the information industry, the chemical industry, the electrical industry, the waste management industry, the manufacturing industry, the motion picture industry, the financial industry, the accounting industry, the agricultural industry, the real estate industry, the banking industry, the automotive industry, the aerospace industry, the alternative energy industry, the telecommunications industry, the retail industry, the insurance industry, the construction industry, the electronics industry, the oil industry, the computing industry, the legal industry, the applications engineering industry, the pharmaceutical industry, the health services industry, the food industry, the lodging industry, the sports industry, the entertainment industry, the design industry, or the like.

For purposes of discussion herein, a “type” associated with a given transaction may refer to a general, high-level classification of the given transaction. Non-limiting examples of a transaction type may include income, taxable income, tax-exempt income, gross income, net income, disposable income, discretionary income, other income, expense, operating expense, non-operating expense, fixed expense, variable expense, other expense, credit card, capital expenditure, sales, purchasing, accounts receivable, accounts payable, current liabilities, non-current liabilities, current assets, non-current assets, fixed assets, cash, cash equivalents, owner's equity, cost of sales, or the like.

For purposes of discussion herein, a “category” assigned to a given transaction may refer to a specific and/or a user's custom classification of the given transaction. Non-limiting examples of a category may include: metal service centers and offices; wholesale clubs; heating, plumbing, and air conditioning contractors; aquariums, seaquariums, dolphinariums, and zoos; bus lines; tolls and bridge fees; optometrists and ophthalmologists; news dealers and newsstands; automotive parts and accessories stores; colleges, universities, professional schools, and junior colleges; hospitals; piece goods, notions, and other dry goods; men's and women's clothing stores; freezer and locker meat provisioners; books, periodicals, and newspapers distributors; art dealers and galleries; real estate agents and managers; furniture; photofinishing laboratories and photo developing; telecommunication equipment and telephone sales; book stores; accounting, auditing, and bookkeeping services; court costs; automotive body repair shops; children's and infants' wear stores; family clothing stores; laundries; miscellaneous apparel and accessory shops; service stations; telegraph services; public warehousing and storage; sports and riding apparel stores; religious organizations; charitable and social service organizations; courier services; hardware, equipment, and supplies; taxicabs and limousines; advertising services; car washes; camera and photographic supply stores; motorcycle shops and dealers; electronics stores; department stores; cosmetic stores; gift, card, novelty and souvenir shops; orthopedic goods; commercial sports, professional sports clubs, athletic fields, and sports promoters; political organizations; landscaping and horticultural services; computers and computer peripheral equipment and software; local and suburban commuter passenger transportation; religious goods stores; household appliance stores; music stores; public golf courses; beauty and barber shops; digital goods; typewriter stores; parking lots, parking meters and garages; artist's supply and craft shops; furniture, home furnishings, and equipment stores; floor covering stores; used merchandise and secondhand stores; discount stores; camper, recreational, and utility trailer dealers; automated fuel dispensers; hearing aids; florists; computer programming, data processing, and integrated systems design services; veterinary services; miscellaneous repair shops and related services; railroads; duty free stores; cleaning, maintenance, and janitorial services; membership clubs; electrical parts and equipment; office and commercial furniture; shoe repair shops, shoe shine parlors, and hat cleaning shops; general contractors; utilities; boat dealers; dry cleaners; motion picture and video tape production and distribution; computer information services; dairy products stores; tourist attractions and exhibits; antique reproductions; airports, flying fields, and airport terminals; tent and awning shops; miscellaneous home furnishing specialty stores; miscellaneous publishing and printing; variety stores; dance halls, studios, and schools; nurseries and lawn and garden supply stores; photographic studios; auto supply; civic, social, and fraternal associations; masonry, stonework, tile setting, plastering, and insulation contractors; osteopaths; snowmobile dealers; legal services and attorneys; digital goods media; electrical and small appliance repair shops; health and beauty spas; drapery, window covering, and upholstery stores; caterers; tire retreading and repair shops; consumer credit reporting agencies; wig and toupee stores; sporting goods stores; grocery stores and supermarkets; women's accessory and specialty shops; swimming pools; specialty cleaning, polishing, and sanitation preparations; plumbing and heating equipment and supplies; buying and shopping services and clubs; cable, satellite, and other pay television or radio services; computer software stores; fuel dealers; medical and dental laboratories; commercial photography, art, and graphics; car and truck dealers, sales, service, repairs, parts, and leasing; elementary and secondary schools; pet shops, pet foods, and supplies stores; roofing, siding, and sheet metal work contractors; video amusement game supplies; watch, clock, and jewelry repair; lumber and building materials stores; electronics repair shops; dentists and orthodontists; automobile rental agency; automotive paint shops; office supplies; correspondence schools; truck and utility trailer rentals; clothing rental; typesetting, plate making, and related services; carpet and upholstery cleaning; stamp and coin stores; commercial footwear; ambulance services; stationery stores, office, and school supply stores; men's and boys' clothing and accessories stores; bicycle shops; motor freight carriers and trucking; air conditioning and refrigeration repair shops; glass, paint, and wallpaper stores; fast food restaurants; direct marketing; exterminating and disinfecting services; men's, women's, and children's uniforms and commercial clothing; paints and varnishes; agricultural co-operatives; tailors, mending, and alterations; electrical contractors; sewing, needlework, fabric, and piece goods stores; marinas, marine service, and supplies; miscellaneous food stores; vocational and trade schools; bowling alleys; motor home and recreational vehicle rentals; fireplace and fireplace screens stores; miscellaneous general merchandise; funeral services and crematories; sporting and recreational camps; furriers and fur shops; towing services; photographic, photocopy, and microfilm equipment; podiatrists and chiropodists; motor homes dealers; home supply warehouse stores; jewelry stores, watches, clocks, and silverware stores; tax payments; bakeries; theatrical producers and ticket agencies; child care services; insurance sales, underwriting, and premiums; equipment, tool, furniture, and appliance rental and leasing; concrete work contractors; restaurants; luggage and leather goods stores; petroleum and petroleum products; architectural, engineering, and surveying services; business and secretarial schools; automobile associations; chiropractors; antique shops; fines; opticians, optical goods, and eyeglasses; welding services; tax preparation services; amusement parks, circuses, carnivals, and fortune tellers; candy, nut, and confectionery stores; hardware stores; information retrieval services; management, consulting, and public relations services; record stores; boat rentals and leasing; quick copy, reproduction, and blueprinting services; bands and orchestras; carpentry contractors; mobile home dealers; stenographic and secretarial support; automotive tire stores; wrecking and salvage yards; motion picture theaters; hobby, toy, and game stores; shoe stores; precious stones, metals, watches, and jewelry; detective agencies, protective services, and security services; motor vehicle supplies; trailer parks and campgrounds; nursing and personal care facilities; florists supplies, nursery stock, and flowers; miscellaneous and specialty retail shops; electric razor stores; passenger railways; billiard and pool establishments; laundry, cleaning, and garment services; or any other appropriate and/or user-custom category incorporated into the system and/or assigned to a transaction.

For purposes of discussion herein, an “original amount” is being entered for a transaction immediately upon a numerical value being entered (e.g., via a user interface, a synchronization process, or the like) into a field associated with a particular transaction, such as a transaction amount field, and such as at a time when the transaction is initially being stored in association with the system, such as in one or more system and/or cloud-based databases. For purposes of discussion herein, a “final amount” stored for a transaction may refer to a value stored in the transaction amount field after (e.g., seconds after, days after, months after, etc.) the transaction is initially stored in association with the system.

For purposes of discussion herein, a “centrality point” or a “measure of central tendency” of a number of data points (e.g., a dataset of numerical values) may refer to a mean (or “average”), a median, a mode, a percentage associated with a mean, median, or mode, a distance from one or more of a mean, median, or mode, or another appropriate value mathematically related to a center of a distribution of the number of data points. For purposes of discussion herein, a “measure of variability” or a “measure of dispersion” for the number of data points may refer to a range, a standard deviation, an inter-quartile range, other quantities associated with outliers, quartiles, or distributions, or another appropriate value mathematically related to variation among a distribution of the data points. For purposes of discussion herein, a “central tendency of variability” associated with the number of data points may refer to a relationship or correlation between two or more measures of central tendency and/or measures of variability associated with the number of data points, such as an average of a plurality of measured standard deviations, a standard deviation of an average number of standard deviations from an average, or another appropriate value representative of a multi-layered relationship or correlation between two or more measures of variability and/or measures of central tendency associated with the number of data points, or any combination of one or more other appropriate mathematical relationships between distance measures, such as Euclidean distances, Minkowski distances, cosine similarities, Manhattan distances, Haversine distances, Jaccard indices, Hamming distances, Sorensen-Dice indices, Chebyshev distances, or the like.

Various implementations of the subject matter disclosed herein provide one or more technical solutions to the technical problem of improving the functionality (e.g., speed, accuracy, etc.) of computer-based data management systems (e.g., computer-based financial management systems), where the one or more technical solutions can be practically and practicably applied to improve on existing techniques for training predictive models to detect anomalies, such as by training a predictive model to validate a transaction amount using an anomaly scoring algorithm generated using a machine learning process based on a number of labels assigned to and/or attributes of a plurality of similar transactions. In addition, or in the alternative, various implementations of the subject matter disclosed herein provide one or more technical solutions to the technical problem of improving the functionality (e.g., speed, accuracy, etc.) of computer-based data management systems (e.g., computer-based financial management systems), where the one or more technical solutions can be practically and practicably applied to improve on existing techniques for detecting an anomaly using a trained predictive model, such as by using a predictive model and an anomaly scoring algorithm generated using a machine learning process to validate a transaction amount based on the transaction's attributes in (at least near) real-time with the amount being entered. Various aspects of the present disclosure provide specific steps describing how these specific results are accomplished and how these specific results realize a technological improvement in computer functionality by means of a unique computing solution to a unique computing problem that did not exist prior to computer-based data management systems that can train predictive models to detect anomalies and/or detect anomalies using a trained predictive model and an anomaly scoring algorithm generated using a machine learning process in real-time, neither of which can be performed in the human mind or using pen and paper. As such, implementations of the subject matter disclosed herein provide specific inventive steps describing how desired results realize meaningful and significant improvements in computer functionality—that is, the performance of ML-based data management systems in the ever-evolving technical field of computer-based data management.

FIG. 1 shows a validation system 100, according to some implementations. The validation system 100 may also be referred to herein as “the system 100.” Various aspects of the system 100 disclosed herein may be generally applicable for training a predictive model to validate a transaction amount, validating a transaction amount using a predictive model, or both. The system 100 may include one or more of an interface 110, one or more databases 120, a transactions database 122, a user database 124, one or more processors 130, a memory 132 coupled to the processor 130, an acquisition engine 140, a characterization engine 148, a training engine 150, a predictive model 154, an adaptation engine 158, a detection engine 160, a prediction engine 162, a classification engine 184, and an action engine 188. In some implementations, the various components of the system 100 are interconnected by at least a data bus 190, as depicted in the example of FIG. 1. In some other implementations, the various components of the system 100 are interconnected using other suitable signal routing resources. While the system 100 and the examples herein are generally described with reference to validation of transaction amounts using machine learning, aspects of the present disclosure may be used to perform other validation techniques, among other suitable tasks.

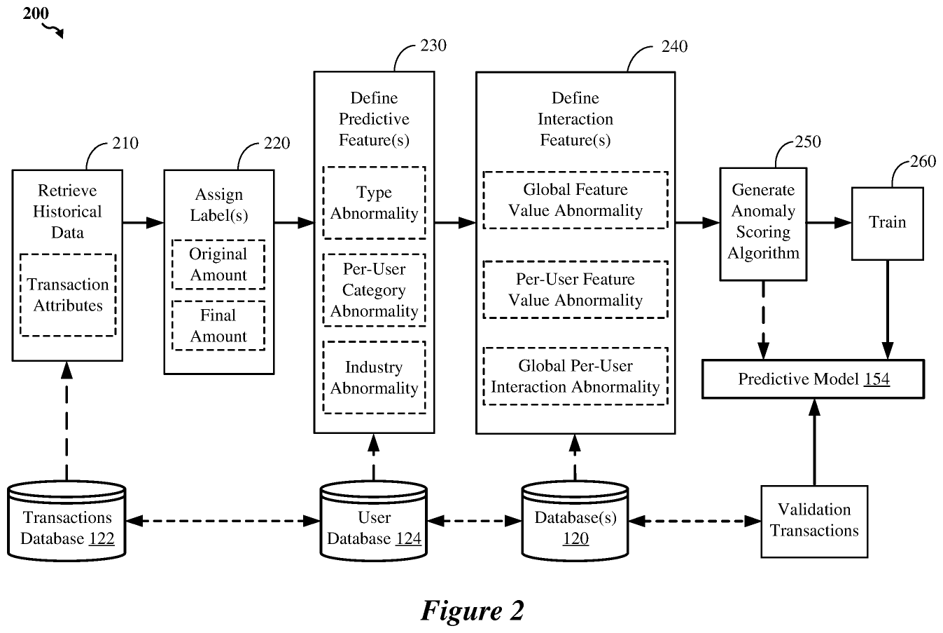

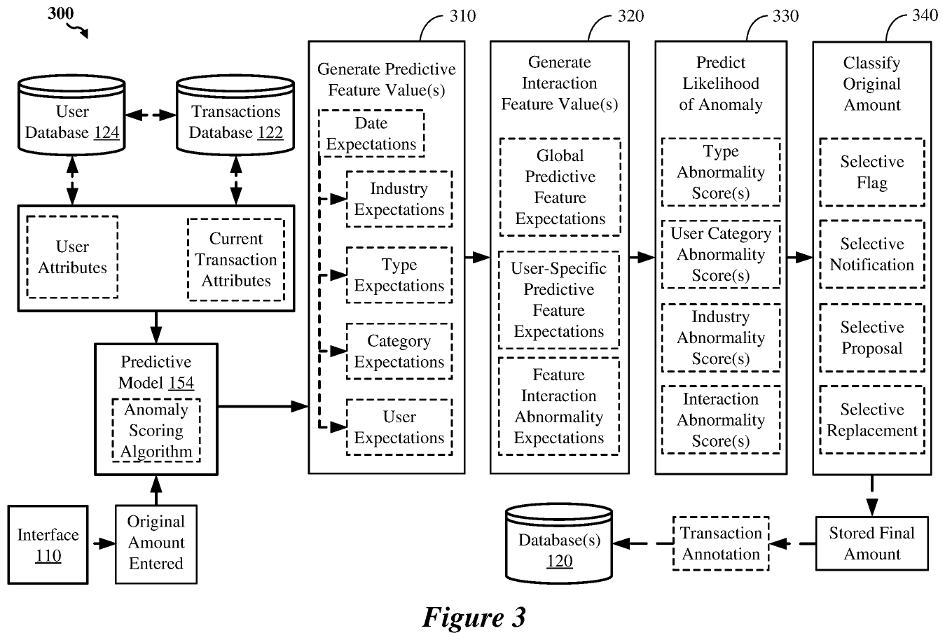

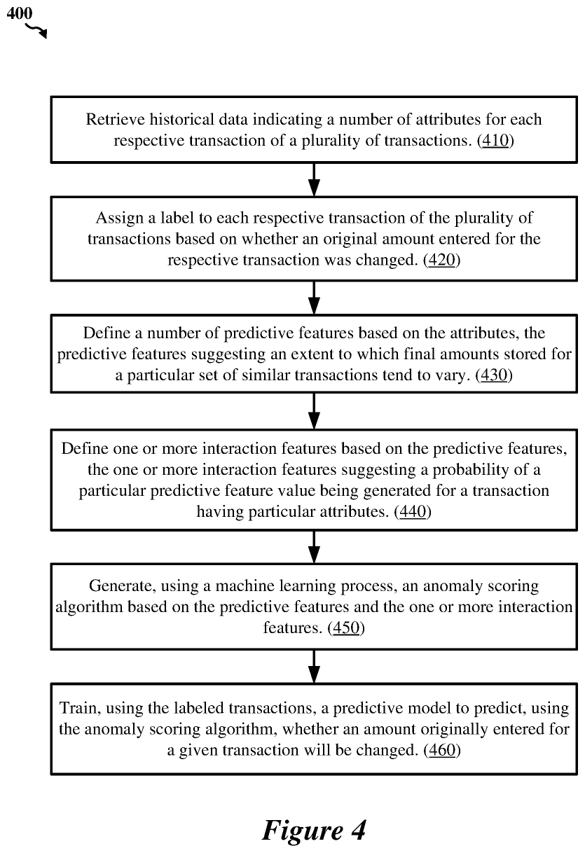

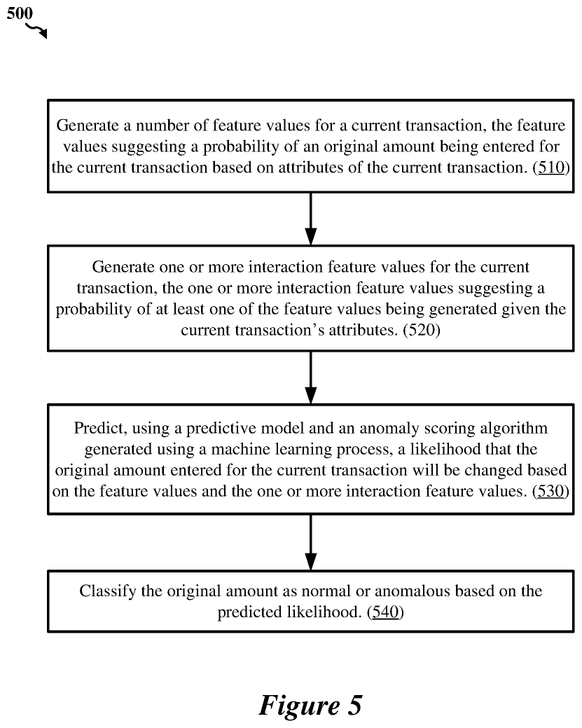

It is to be understood that, in some implementations, the system 100 may be configured to train a predictive model to validate a transaction amount, as further described below in connection with the acquisition engine 140, the characterization engine 148, the training engine 150, and the adaptation engine 158—as well as with respect to FIG. 2 and FIG. 4—and that in such implementations, the system 100 may not be configured to validate a transaction amount in real-time, and thus may not include one or more of the detection engine 160, the prediction engine 162, the classification engine 184, or the action engine 188. It is further to be understood that, in some other implementations, the system 100 may be configured to use a trained predictive model to validate a transaction amount, as further described below in connection with the detection engine 160, the prediction engine 162, the classification engine 184, and the action engine 188—as well as with respect to FIG. 3 and FIG. 5—and that in such implementations, the system 100 may not be configured to train a predictive model to validate a transaction amount, and thus may not include one or more of the acquisition engine 140, the characterization engine 148, the training engine 150, or the adaptation engine 158. It is further to be understood that, in yet other implementations, the system 100 may be configured to both train a predictive model to validate a transaction amount and validate an amount of a current transaction using the trained predictive model.

The interface 110 may be one or more input/output (I/O) interfaces for receiving input data, such as a transaction amount entered by a user. The interface 110 may also be used to present information to a user, such as a notification that a transaction amount may be inaccurate, a request to enter a replacement transaction amount, or the like. The interface 110 may also be used to provide or receive other suitable information, such as computer code for updating one or more programs stored on the system 100, internet protocol requests and results, or the like. An example interface may include a wired interface or wireless interface to the internet or other means to communicably couple with user devices or any other suitable devices. For example, the interface 110 may include an interface with an ethernet cable to a modem, which is used to communicate with an internet service provider (ISP) directing traffic to and from user devices and/or other parties. The interface 110 may also be used to communicate with another device within the network to which the system 100 is coupled, such as a smartphone, a tablet, a personal computer, or other suitable electronic device. The interface 110 may also include a display, a speaker, a mouse, a keyboard, or other suitable input or output elements that allow interfacing with the system 100 by a local user or moderator.

The database 120 may store any data associated with the system 100, such as one or more transaction attributes, transaction amounts entered, transaction amounts stored, labels and/or annotations, algorithms, training data, validation data, user information, industry information, date-related information, transaction category information, transaction type information, information associated with predictive features, interaction features, and/or feature values, among other suitable information, such as one or more system objects, JSON (JavaScript Object Notation) files, or any other appropriate data. The database 120 may be a part of or separate from the transactions database 122, the user database 124, and/or another appropriate physical or cloud-based data store. In some implementations, the database 120 may include a relational database capable of presenting information as data sets in tabular form and capable of manipulating the data sets using relational operators. The database 120 may use Structured Query Language (SQL) for querying and maintaining the database 120. The input data and the data sets described below may be in any suitable format for processing by the system 100. For example, the data may be included in one or more JSON files or objects. In another example, the data may be in SQL compliant data sets for filtering and sorting by the system 100 (such as by the processor 130).

The transactions database 122 and/or the user database 124 may store data corresponding to a plurality of transactions, a number of attributes indicative of characteristics of the plurality of transactions, information about users associated with the plurality of transactions, among other appropriate data. In some instances, the transactions database 122 includes data stored in one or more cloud object storage services, such as one or more Amazon Web Services (AWS)-based Simple Storage Service (S3) buckets. In some implementations, all or a portion of the data may be stored in a memory separate from the transactions database 122 or the user database 124, such as the database 120 or another suitable data store. As non-limiting examples, a given attribute may indicate, for a respective transaction, one of a plurality of transaction types (e.g., income, expense) associated with the respective transaction, one of a plurality of categories (e.g., supplies, tips, tools, travel) assigned to the respective transaction, a date (e.g., Aug. 31, 2020; Apr. 2, 2021) on which the respective transaction occurred, an original amount entered (e.g., $844) for the respective transaction, a final amount stored (e.g., $84) for the respective transaction, or any other appropriate characteristic of the respective transaction. In some instances, the transactions database 122 and/or the user database 124 may store attributes that indicate, for a respective transaction, one of a plurality of users (e.g., userId=Eliyahu, userId=Tayeb) associated with the respective transaction and/or one of a plurality of industries (e.g., education, finance, arts, healthcare) in which an associated user operates. In some implementations, the transactions database 122 stores data indicative of attributes of transactions being entered in real-time, as further described below in connection with the prediction engine 162. The transactions database 122 and/or the user database 124 may be a part of or separate from the database 120.

In some implementations, transaction attributes may be stored (or “cataloged”) within metadata fields common to two or more of the database 120, the transactions database 122, the user database 124, or another appropriate data store. As a non-limiting example, a particular transaction may be associated with a particular user identifier (userID) in the transactions database 122, indicating that the user associated with the particular userID entered the particular transaction, and a particular industry may be associated with the same, particular userID in the user database 124, indicating that the user operates within the particular industry. By incorporating information from the transactions database 122 and/or the user database 124, the system 100 may determine a user associated with a given transaction and an industry in which the associated user operates.

The processor 130 may include one or more suitable processors capable of executing scripts or instructions of one or more software programs stored in system 100, such as within the memory 132. The processor 130 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In some implementations, the processor 130 may include a combination of computing devices, such as a combination of a DSP and a microprocessor, a plurality of microprocessors, one or more microprocessors in conjunction with a DSP core, or any other suitable configuration.

The memory 132, which may be any suitable persistent memory (such as non-volatile memory or non-transitory memory) may store any number of software programs, executable instructions, machine code, algorithms, and the like that can be executed by the processor 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The acquisition engine 140 may be used to retrieve, or otherwise acquire, a plurality of transactions, such as from one or more of the database 120, the transactions database 122, the user database 124, the interface 110, or another appropriate source. In some instances, one or more of the transactions may initially be unlabeled (e.g., not indicate whether an amount originally entered for the transaction was changed), as further described below in connection with the characterization engine 148. In some other instances, one or more of the transactions may be prelabeled (e.g., indicate whether an amount originally entered for the transaction was changed), as further described below in connection with the adaptation engine 158. The acquisition engine 140 may provide the acquired transactions to the characterization engine 148.

The characterization engine 148 may be used to retrieve data indicating a number of attributes for each respective transaction of the plurality of transactions. For example, the characterization engine 148 may retrieve, from the transactions database 122 and/or the user database 124, historical data indicating, for each respective transaction, a user associated with the respective transaction, an industry in which the associated user operates, a category assigned to the respective transaction (such as by the associated user), a transaction type associated with the respective transaction, a date that the respective transaction occurred, an original amount entered for the respective transaction (such as by the associated user), and a final amount stored for the respective transaction (such as a most recent transaction value stored for the transaction according to the historical data, which in some instances, may be the original amount).

The characterization engine 148 may also be used to assign a label to unlabeled ones of the plurality of transactions. In some implementations, the characterization engine 148 may label the transactions based on whether an original amount entered for the transaction was changed—that is, whether a final amount stored for the transaction is different than the original amount entered (e.g., the day before the final amount is stored). For example, the characterization engine 148 may assign a first label (e.g., 0, “normal,” “legitimate”) to a transaction if the original amount entered is the same as the final amount stored, and assign a second label (e.g., 1, “anomaly,” “edited”) to the transaction if the original amount entered is different than the final amount stored. In this manner, the characterization engine 148 can indicate, for each labeled transaction, whether the original amount appears to be a mistake or error. In some implementations, the plurality of unlabeled transactions include some portion (e.g., 25%) of a total number of transactions stored in the transactions database 122 or another appropriate (e.g., cloud-based) database. For example, the final amount stored for a given transaction may be obtained after the given transaction is reconciled with a particular (e.g., external) source, which may occur on the same day as or some number of days after (e.g., 1) the original amount is entered. In these and other manners, the system 100 may train the predictive model in a supervised manner based on the labeled transactions.

The characterization engine 148 may also be used to define a number of predictive features based on the attributes, where each of the predictive features suggests an extent to which final amounts stored for transactions that share particular characteristics tend to vary. In other words, the predictive features may be indicative of a relative abnormality of original amounts entered for transactions that share particular characteristics, such as transactions that have a same value for one or more attributes (e.g., the date that the transactions occurred, the user associated with the transactions, the type of the transactions, the category assigned to the transactions, and/or any other appropriate attribute the transactions may share). The particular characteristics may further include an original amount entered for the transaction and/or a final amount stored for the transaction.

In some implementations, the number of predictive features may be used as input feature segments for an anomaly scoring algorithm, which may be used in conjunction with a predictive model to predict whether the original amount is an anomaly, such as based on a number of distinct axes (e.g., 3 or more). A first example input feature segment for the anomaly scoring algorithm may allow the predictive model to detect anomalous transaction amounts based on a first axis of a given transaction's attributes, such as a type of the transaction and/or its seasonality. A second example input feature segment for the anomaly scoring algorithm may allow the predictive model to detect anomalous transaction amounts based further on a second axis of the given transaction's attributes, such as an industry in which a user associated with the given transaction operates and/or its seasonality. A third example input feature segment for the anomaly scoring algorithm may allow the predictive model to detect anomalous transaction amounts based further on a third axis of the given transaction's attributes, such as a degree of uniqueness for transactions assigned a particular category for a particular user associated with the given transaction—that is, a first-layer comparative analysis within the particular user's transactions. In some implementations, the characterization engine 148 may provide the definitions of the number of predictive features to the training engine 150 for further processing. Non-limiting examples of predictive features that the characterization engine 148 may define are described below.

In some implementations, the characterization engine 148 may be used to define a type abnormality feature suggesting an extent to which final amounts stored for transactions of a specified transaction type tend to vary, such as during a specified time period (e.g., a seasonality associated with the specified transaction type). In other words, the characterization engine 148 may generate, for each transaction type, one or more statistical (e.g., centrality) measures across (e.g., all or some portion of all) users, such that a relative distance between any given transaction amount and one or more of the statistical measures may be determined. For example, the characterization engine 148 may define the type abnormality feature by grouping the plurality of transactions into sets of same-type transactions based on the historical data, where each transaction of each set of same-type transactions occurred during a same time period and is of a same transaction type, determining a centrality point of the final amounts stored for each set of same-type transactions, determining, for each set of same-type transactions, a measure of variability between the centrality point and each final amount stored for the corresponding set of same-type transactions, and determining, based on the corresponding measures of variability, a central tendency of variability among the final amounts stored for each set of same-type transactions. In some implementations, the characterization engine 148 may selectively apply one or more type seasonality weights to the corresponding measures of variability based on whether the associated transaction occurred before or after a particular date (e.g., such as after December 31 of the previous year), during a particular range of dates (e.g., such as a most recent previous month, or any other appropriate time window), or within a particular pattern deemed relevant to the corresponding transaction type. An example type seasonality weight may attribute less weight to variabilities among final amounts stored for income-type transactions occurring in December than to income-type transactions occurring in April, such as to account for holiday sales. Another example type seasonality weight may attribute less weight to variabilities among final amounts stored for all expense-type transactions occurring within a specified range of dates (e.g., between March 2020 and March 2021), such as to account for less overall spending during global pandemic-related quarantines.

As a non-limiting example, the type abnormality feature may characterize a central tendency of variability among final amounts stored for income-type transactions occurring in December, such as a most recent December or any number of, including all, Decembers represented in the historical data. For this example, the characterization engine 148 may identify, among the historical data, a group of income-type transactions that occurred between December 1 and December 31 during the four most recent Decembers (e.g., December 2018, December 2019, December 2020, and December 2021), determine an average final amount stored for the identified group of income-type transactions, determine, for each final amount, a number of standard deviations between the final amount and the average final amount, and determine an average number of standard deviations from the average final amount for the final amounts stored—that is, a central tendency of variability among final amounts stored for income-type transactions occurring during the most recent four Decembers. The system 100 may then determine a relative abnormality of an original amount entered for an income-type transaction occurring in December (e.g., December 2022) based at least in part on the determined central tendency of variability, as is described by example with respect to the prediction engine 162. It is to be understood that the characterization engine 148 may use any other appropriate combination of statistical measures or patterns to identify a relative abnormality of an original amount entered for a transaction of a particular type. For this example, the characterization engine 148 may attribute less weight to variabilities among final amounts stored for transactions occurring more than two years ago, such as by applying a first weight (e.g., 0.5) to the standard deviations associated with the transactions from December 2018 and December 2019, and a second weight (e.g., 1.0) to the standard deviations associated with the transactions from December 2020 and December 2021. In this manner, values associated with more recent transactions may have a greater impact on the central tendency of variability than values associated with less recent transactions. One or more other appropriate weights may be applied, such as a weighted value that gradually decays for transactions occurring further in the past.

In some implementations, the characterization engine 148 may be used to define an industry abnormality feature suggesting an extent to which final amounts stored for transactions associated with users operating in a specified industry tend to vary, such as during a specified time period (e.g., a seasonality associated with the specified industry). In other words, the characterization engine 148 may generate, for each industry, one or more statistical (e.g., centrality) measures across (e.g., all or some portion of all) users, such that a relative distance between any given transaction amount and one or more of the statistical measures may be determined. For example, the characterization engine 148 may define the industry abnormality feature by grouping the plurality of transactions into sets of same-industry transactions based on the historical data, where each transaction of each set of same-industry transactions occurred during a same time period and is associated with a user operating in a same industry, determining a centrality point of the final amounts stored for each set of same-industry transactions, determining, for each set of same-industry transactions, a measure of variability between the centrality point and each final amount stored for the corresponding set of same-industry transactions, and determining, based on the corresponding measures of variability, a central tendency of variability among the final amounts stored for each set of same-industry transactions. In some implementations, the characterization engine 148 may selectively apply one or more industry seasonality weights to the corresponding measures of variability based on whether the associated transaction occurred before or after a particular date, during a particular range of dates, or within a particular pattern deemed relevant to the corresponding industry. An example industry seasonality weight may attribute less weight to variabilities among final amounts stored for all transactions associated with users operating in the real estate industry, which may have a relatively high variability in general, such as compared with transactions associated with users operating in the pharmaceutical industry, which may have relatively low variability in general.

As a non-limiting example, the industry abnormality feature may characterize a central tendency of variability among final amounts stored for transactions associated with users operating in the lawn care industry. For this example, the characterization engine 148 may identify, among the historical data, all transactions associated with users operating in the lawn care industry, determine an average final amount stored for the identified transactions, determine, for each final amount, a number of standard deviations between the final amount and the average final amount, and determine an average number of standard deviations from the average final amount for the final amounts stored—that is, a central tendency of variability among final amounts stored for transactions associated with users operating in the lawn care industry. In some implementations, the industry abnormality feature may further characterize the central tendency of variability based on whether the transactions occurred during summer months or winter months, such as to account for more lawn care activity during the summer. The system 100 may then determine a relative abnormality of an original amount entered for a transaction associated with a user operating in the lawn care industry based at least in part on the determined central tendency of variability, as is described by example with respect to the prediction engine 162. It is to be understood that the characterization engine 148 may use any other appropriate combination of statistical measures or patterns to identify a relative abnormality of an original amount entered for a transaction associated with a user operating in a particular industry. For this example, the characterization engine 148 may attribute less weight to variabilities among final amounts stored for transactions associated with users operating in the lawn care industry in a particular location during a particular range of dates, such as users operating in the lawn care industry in California during a time period associated with a government mandate to reduce water-based lawn care activities, such as during a drought. One or more other appropriate weights may be applied.

In some implementations, the characterization engine 148 may be used to define a per-user category abnormality feature suggesting, for each respective user of a plurality of users, an extent to which final amounts stored for transactions assigned a specified category tend to vary for the unique, respective user, such as during a specified time period (e.g., a seasonality associated with the specified category and/or the specified user). In other words, the characterization engine 148 may generate, for each respective category of the unique user's transaction categories, one or more statistical (e.g., centrality) measures across the user's transactions that are assigned the respective category, such that a relative distance between an amount entered for any one of the user's transactions and one or more of the statistical measures may be determined. For example, the characterization engine 148 may define the per-user category abnormality feature by grouping, for each respective user, the plurality of transactions into sets of same-category transactions based on the historical data, where each transaction of each set of same-category transactions is associated with a same respective user and is assigned a same category, determining, for each respective user, a centrality point of the final amounts stored for each set of same-category transactions associated with the respective same user, determining, for each set of same-category transactions, a measure of variability between the centrality point and each final amount stored for the corresponding set of same-category transactions, and determining, based on the corresponding measures and for each respective user, a central tendency of variability among the final amounts stored for each set of same-category transactions associated with the respective same user. In some implementations, the characterization engine 148 may selectively apply one or more user seasonality weights to the corresponding measures of variability based on whether the associated transaction occurred before or after a particular date, during a particular range of dates, or within a particular pattern deemed relevant to the corresponding category. An example user seasonality weight may attribute less weight to variabilities among final amounts stored for transactions occurring during July and assigned a “travel” category for a user that, historically, has spent a relatively high amount on “travel” during July, such as for annual retreats. Another example user seasonality weight may attribute less weight to variabilities among final amounts stored for transactions occurring during December and assigned a “gift” category, such as to account for an identified pattern showing that given users generally spend more on gifts during December.

As a non-limiting example, the per-user category abnormality feature may characterize, for a respective user, a central tendency of variability among final amounts stored for the respective user's transactions assigned a “travel” category. For this example, the characterization engine 148 may identify, among the historical data, the respective user's transactions assigned a “travel” category, determine an average final amount stored for the identified transactions, determine, for each final amount, a number of standard deviations between the final amount and the average final amount, and determine an average number of standard deviations from the average final amount for the final amounts stored—that is, a central tendency of variability among final amounts stored for the respective user's transactions assigned the “travel” category. In some implementations, the per-user category abnormality feature may further characterize the central tendency of variability based on whether the transactions occurred on particular days of the week, such as if the respective user tends to spend relatively more on travel on Mondays and Fridays. The system 100 may then determine a relative abnormality of an original amount entered for a transaction assigned the “travel” category for the respective user based at least in part on the determined central tendency of variability, as is described by example with respect to the prediction engine 162. It is to be understood that the characterization engine 148 may use any other appropriate combination of statistical measures, patterns, or weights to identify a relative abnormality of an original amount entered for a transaction associated with a given user and assigned a particular category.

In some implementations, the characterization engine 148 may be used to define one or more interaction features based on the predictive features, the one or more interaction features suggesting a probability of a particular predictive feature value being generated for a transaction having particular attributes. In other words, the one or more interaction features may compare a first-layer analysis of transactions (such as a category abnormality feature for a particular user) with a second-layer analysis of transactions associated with some global number of users, which may include all users or a selected portion of all users. In some implementations, one or more of the interaction features take into account whether the associated transactions occurred on a given date (e.g., a seasonality associated with the specified input feature). In some implementations, the characterization engine 148 may provide the one or more interaction features to the training engine 150 for further processing.

As a non-limiting example of a second-layer interaction feature, the characterization engine 148 may define a global category interaction feature based on the per-user category abnormality feature described above, where the global category interaction feature suggests a probability of a category abnormality feature value being generated for a transaction associated with a given user and assigned a given category—that is, an extent to which the user category abnormality feature tends to vary for transactions associated with the given user and assigned the given category. In other words, the characterization engine 148 may generate, for each respective category of a plurality of categories across users globally, one or more statistical (e.g., centrality) measures across each respective user's transactions that are assigned the respective category, such that a relative distance between an amount entered for any user's transaction and one or more of the statistical measures may be determined.

As another non-limiting example of a second-layer interaction feature, the characterization engine 148 may define a global industry interaction feature based on the industry abnormality feature described above, where the global industry interaction feature suggests a probability of an industry abnormality feature value being generated for a transaction associated with a user that operates in a given industry—that is, an extent to which the industry abnormality feature tends to vary for transactions associated with users operating in the given industry. In other words, the characterization engine 148 may generate, for each respective industry of a plurality of industry across users globally, one or more statistical (e.g., centrality) measures across the transactions associated with the respective industry, such that a relative distance between an amount entered for a transaction associated with the respective industry and one or more of the statistical measures may be determined.

As another non-limiting example of a second-layer interaction feature, the characterization engine 148 may define a global type interaction feature based on the type abnormality feature described above, where the global type interaction feature suggests a probability of a type abnormality feature value being generated for a transaction of a specified type—that is, an extent to which the type abnormality feature tends to vary for transactions associated with transactions of the specified type. In other words, the characterization engine 148 may generate, for each respective type of a plurality of transaction types, one or more statistical (e.g., centrality) measures across the transactions of the respective type, such that a relative distance between an amount entered for a transaction of the respective type and one or more of the statistical measures may be determined.

The training engine 150 may be used to generate a predictive algorithm based on at least one of the number of predictive features (the first-layer features) and the interaction features (the second-layer features). The training engine 150 may use a machine learning (ML) process to generate the anomaly scoring algorithm, where the machine learning process determines an appropriate weighting factor for each feature of the anomaly scoring algorithm, such as a statistically most optimal weighting factor for at least one of the input features (e.g., the type abnormality feature, the industry abnormality feature, the per-user category abnormality feature, the global category interaction feature, the global industry interaction feature, the global type interaction feature, or another appropriate abnormality feature). In some implementations, an output of any given global interaction feature represents an interaction between the input feature segments associated with the given global interaction feature. For instance, the anomaly scoring algorithm may incorporate a type feature suggesting an extent to which final amounts stored for transactions of specified transaction types tend to vary, an industry feature suggesting an extent to which final amounts stored for transactions associated with users operating in specified industries tend to vary, a category feature suggesting an extent to which final amounts stored for transactions assigned specified categories tend to vary for specified users, and an interaction feature suggesting, for example, an extent to which the category feature tends to vary for transactions assigned specified categories and associated with specified users.

The training engine 150 may also be used to train the predictive model 154 to generate, using the anomaly scoring algorithm, predictions and/or likelihoods associated with transactions based on a concatenation of the incorporated predictive feature values and the incorporated interaction feature values. The training engine 150 may train the predictive model 154 using historical data indicating a number of attributes for a plurality of transactions, as described above with respect to the acquisition engine 140.

The predictive model 154 may be trained to validate a transaction amount based on a likelihood that the transaction amount is an anomaly—that is, once trained, the predictive model 154 may be used to predict, using the anomaly scoring algorithm, whether an original amount entered for a transaction will be changed, such as based on a user associated with the transaction, an industry in which the user operates, a category assigned to the transaction, a type of the transaction, and/or a date on which the transaction occurred. The predictive model 154 may be a classification model that incorporates the aspects described herein, as well as one or more aspects of, for example, random forests, logistic regression, one or more decision trees, nearest neighbors, classification trees, control flow graphs, support vector machines, naïve Bayes, Bayesian Networks, value sets, hidden Markov models, or neural networks configured to generate predictions for the intended purpose. In some aspects, the predictive model 154 may incorporate aspects of a neural network of a suitable type, such as a feedforward neural network or a recurrent neural network. For example, the predictive model 154 may incorporate aspects of a deep neural network (DNN), which may have a suitable architecture, such as a feedforward architecture or a recurrent architecture. In some other implementations, the predictive model 154 may incorporate aspects of a forecasting model such that predictive values are generated based at least in part on previous values associated with one or more input features, including interaction input features. Example forecasting models include one or more of an autoregressive (AR) model or a window function. Example AR models to predict values from time series data include an autoregressive integrated moving average (ARIMA) model, Fakebook's Prophet model, or an exponential smoothing model. Example window functions may include a simplified moving average, an exponential moving average, stochastic based smoothing, or a naive forecasting model. Predictions by an example window function may be based on one or more of a mean, a minimum, or a maximum of a predefined number of values in a time series data preceding a predicted value. Although aspects of the present disclosure are generally described with respect to a ML-based classifier, it is to be understood that the predictive model 154 may incorporate aspects of any number of classification or regression models, and is not limited to the provided examples or a particular model type.

The adaptation engine 158 may be used to validate the predictive model 154—that is, determine an accuracy at which the predictive model 154 predicts whether transaction amounts are anomalies. The adaptation engine 158 may validate the predictive model 154 by comparing its predictions with validation data, such as prelabeled transactions indicating whether original amounts entered for the transactions are different than the corresponding final amounts stored. In some implementations, the acquisition engine 140 generates at least some of the labels based on the original amounts entered and the final amounts stored for the transactions, as further described above. In some other implementations, the action engine 188, or another appropriate component, generates at least some of the labels, as further described below. By determining an accuracy at which the predictive model 154 can predict whether a transaction amount is an anomaly, the adaptation engine 158—in conjunction with the training engine 150—can use additional data associated with additional transactions to iteratively train and validate the predictive model 154 until the accuracy of the predictive model 154 is greater than a value, such as a desired threshold.

In these and other manners, the system 100 may be used to train a predictive model to validate a transaction amount—that is, one or more of the acquisition engine 140, the characterization engine 148, the training engine 150, and the adaptation engine 158, may be used to train the predictive model 154 to predict, using the anomaly scoring algorithm, whether an original amount entered for a given transaction will be changed. In addition, or in the alternative, the system 100 may be used to validate a transaction amount—such as by using a trained predictive model in at least near real-time with the transaction amount being entered—as further described below in connection with the detection engine 160, the prediction engine 162, the classification engine 184, and the action engine 188.

The detection engine 160 may be used to detect a transaction amount, such as an original amount being entered (e.g., by a user via the interface 110) for a current transaction in real-time. The detection engine 160 may also be used to identify, or otherwise retrieve, a number of attributes associated with the current transaction, such as from one or more of the database 120, the transactions database 122, the user database 124, or another appropriate database. For example, the detection engine 160 may identify one or more of a type of the current transaction, a category assigned to the current transaction, or a date on which the current transaction occurred based on information stored in the transactions database 122. As another example, the detection engine 160 may identify a user associated with the current transaction (such as a user entering the original amount) and an industry in which the user operates based on information stored in the user database 124. In some implementations, the detection engine 160 may provide the original amount to the prediction engine 162 for further processing.

The prediction engine 162 may be used to generate a number of feature values for the current transaction based on the attributes, where the feature values suggest a probability of an original amount being entered for the current transaction, and contributes to an overall abnormality score for the current transaction, where the overall abnormality score suggests a relative likelihood that the original amount will be changed, or is otherwise an anomaly. Non-limiting examples of feature values that the prediction engine 162 may generate are described below.

In some implementations, the prediction engine 162 may be used to generate a type abnormality score for the original amount entered for the current transaction suggesting a probability of the original amount being entered based on a type of the current transaction (e.g., income, expense), and in some instances, based on a date on which the current transaction occurred. In some aspects, the prediction engine 162 may automatically determine the date on which the transaction occurred based on synchronized metadata associated with the transaction, and in some other aspects, the date may be entered manually by a user associated with the transaction. In some implementations, the prediction engine 162 may generate the type abnormality score based on a corresponding portion of an anomaly scoring algorithm generated using a machine learning process, such as based on the type abnormality feature described in connection with the characterization engine 148. For example, given the type of the current transaction, the prediction engine 162 may generate the type abnormality score based on identifying a set of same-type transactions relevant to the current transaction, determining a current measure of variability between the original amount and a centrality point of the final amounts stored for the set of same-type transactions, and determining a difference between the current measure of variability and a central tendency of variability for the set of same-type transactions. In some implementations, the prediction engine 162 may identify the same-type transactions among a plurality of transactions stored in the transactions database 122, such as by matching ones of the plurality of transactions having the same transaction type. In some implementations, the type abnormality score is proportional to the difference between the current measure of variability and the central tendency of variability—that is, an abnormality of the original amount will be relatively high or low when the difference is relatively high or low, respectively. In some aspects, one or more of the centrality point of final amounts and the central tendency of variability for the set of same-type transactions is predetermined, and thus the prediction engine 162 may conserve processing and memory resources by retrieving the predetermined values from a database (e.g., the transactions database 122). In some other aspects, the prediction engine 162 may determine one or more of the centrality point of the final amounts and the central tendency of variability in real-time, such as if one or more of said values are outdated or otherwise unavailable.

In some instances, the prediction engine 162 may generate the type abnormality score further based on a date on which the current transaction occurred, such as if the anomaly scoring algorithm incorporates one or more type seasonality weights that increase or decrease the type abnormality score based on whether the current transaction occurred before or after a particular date, during a particular range of dates, and/or within a particular pattern deemed relevant to the transaction type. As a non-limiting example, a type seasonality weight may decrease the type abnormality score for a given transaction (i.e., decrease a determined abnormality of the original amount entered for the given transaction) if the given transaction is an income-type transaction that occurred in December, such as to account for an expected global variation in holiday sales. It is to be understood that the prediction engine 162 may use any other appropriate combination of statistical measures or patterns incorporated into the anomaly scoring algorithm to determine a relative abnormality of the original amount based on the transaction type, and in some instances, further based on the date on which the transaction occurred.

In some implementations, the prediction engine 162 may be used to generate an industry abnormality score for the original amount entered for the current transaction suggesting a probability of the original amount being entered based on a user associated with the current transaction and an industry (e.g., auto repair) in which the associated user operates, and in some instances, based on a date on which the current transaction occurred. In some implementations, the prediction engine 162 may generate the industry abnormality score based on a corresponding portion of the anomaly scoring algorithm, such as the industry abnormality feature described in connection with the characterization engine 148. For example, given the industry in which the user associated with the transaction operates, the prediction engine 162 may generate the industry abnormality score based on identifying a set of same-industry transactions relevant to the current transaction, determining a current measure of variability between the original amount and a centrality point of the final amounts stored for the set of same-industry transactions, and determining a difference between the current measure of variability and a central tendency of variability for the set of same-industry transactions. In some implementations, the prediction engine 162 may identify the same-industry transactions among a plurality of transactions stored in the transactions database 122, such as by matching ones of the plurality of transactions associated with users operating in the same industry. In some implementations, the industry abnormality score is proportional to the difference between the current measure of variability and the central tendency of variability—that is, an abnormality of the original amount will be relatively high or low when the difference is relatively high or low, respectively. In some aspects, one or more of the centrality point of final amounts and the central tendency of variability for the set of same-industry transactions is predetermined, and thus the prediction engine 162 may conserve processing and memory resources by retrieving the predetermined values from a database (e.g., one or more of the transactions database 122 or the user database 124). In some other aspects, the prediction engine 162 may determine one or more of the centrality point of the final amounts and the central tendency of variability in real-time, such as if one or more of said values are outdated or otherwise unavailable.

In some instances, the prediction engine 162 may generate the industry abnormality score further based on a date on which the current transaction occurred, such as if the anomaly scoring algorithm incorporates one or more industry seasonality weights that increase or decrease the industry abnormality score based on whether the current transaction occurred before or after a particular date, during a particular range of dates, and/or within a particular pattern deemed relevant to the given industry. As a non-limiting example, an industry seasonality weight may increase the industry abnormality score for a given transaction (i.e., increase a determined abnormality of the original amount entered for the given transaction) if the given transaction is associated with a user operating in the pharmaceutical industry, such as to account for an expected consistency of transaction amounts for users operating in the pharmaceutical industry. As another non-limiting example, an industry seasonality weight may decrease the industry abnormality score for a given transaction (i.e., decrease a determined abnormality of the original amount entered for the given transaction) if the given transaction is associated with a user operating in the real estate industry, such as to account for a relatively high expected variability of transaction amounts associated with users operating in the real estate industry. It is to be understood that the prediction engine 162 may use any other appropriate combination of statistical measures or patterns incorporated into the anomaly scoring algorithm to determine a relative abnormality of the original amount based on the industry in which the associated user operates, and in some instances, further based on the date on which the transaction occurred.

In some implementations, the prediction engine 162 may be used to generate a user category abnormality score for the original amount entered for the current transaction suggesting a probability of the original amount being entered based on a particular user associated with the current transaction and a category assigned to the current transaction (e.g., office supplies), and in some instances, based on a date on which the current transaction occurred. In some implementations, the prediction engine 162 may generate the user category abnormality score based on a corresponding portion of the anomaly scoring algorithm, such as the per-user category abnormality feature described in connection with the characterization engine 148. For example, given the user associated with the transaction and the assigned category, the prediction engine 162 may generate the user category abnormality score based on identifying a set of same-category transactions associated with the given user, determining a user centrality point (e.g., an average) of final amounts stored for the same-category transactions, determining, for each final amount, a historical measure of variability (e.g., a number of standard deviations) between the final amount and the user centrality point, determining a central tendency of variability (e.g., an average of the determined numbers of standard deviations), determining a current measure of variability (e.g., a number of standard deviations) between the original amount entered for the current transaction and the user centrality point, and determining a difference between the current measure of variability and the central tendency of variability. In some implementations, the prediction engine 162 may identify the user-relevant same-category transactions by matching ones of the user's transactions assigned the same category in one or more databases. In some implementations, the user category abnormality score is proportional to the difference between the current measure of variability and the central tendency of variability—that is, an abnormality of the original amount will be relatively high or low when the difference is relatively high or low, respectively. In some aspects, the prediction engine 162 may retrieve one or more of the centrality point of final amounts, the historical measure of variability, and the central tendency of variability for the same-category transactions from a database (e.g., one or more of the transactions database 122 or the user database 124), such as if said values were previously determined for the given user. In some other aspects, the prediction engine 162 may determine one or more of said values for the given user in real-time (such as immediately upon the original amount being entered), which may consume significantly less processing and memory resources than for processing information associated with multiple users, such as hundreds or thousands of users, or more.

In some instances, the prediction engine 162 may generate the user category abnormality score further based on a date on which the current transaction occurred, such as if the anomaly scoring algorithm incorporates one or more user seasonality weights that increase or decrease the user category abnormality score based on whether the current transaction occurred before or after a particular date, during a particular range of dates, and/or within a particular pattern deemed relevant to the given category and user. As a non-limiting example, a user seasonality weight may decrease the user category abnormality score for a given transaction (i.e., decrease a determined abnormality of the original amount entered for the given transaction) if the transaction occurred in July, is assigned a “travel” category, and the associated user has historically entered relatively higher amounts for “travel” during July than other months, such as if the user tends to host an annual retreat in July. It is to be understood that the prediction engine 162 may use any other appropriate combination of statistical measures or patterns incorporated into the anomaly scoring algorithm to determine a relative abnormality of the original amount based on the user associated with the transaction and the category assigned to the current transaction, and in some instances, further based on the date on which the transaction occurred.

The prediction engine 162 may also be used to generate one or more interaction feature values for the current transaction based on the attributes and at least one of the feature values, where the one or more interaction feature values suggesting a relative abnormality of at least one of the feature values given the attributes of the current transaction. In some implementations, the one or more interaction feature values further contribute to the overall abnormality score for the current transaction.

As a non-limiting example of an interaction feature value, the prediction engine 162 may be used to generate a category interaction abnormality score for the original amount entered for the current transaction suggesting a probability of the user category abnormality score being generated for the current transaction (such as for the transaction associated with the user category abnormality score described above) based on user category abnormality scores generated for other users' transactions assigned the same category, and in some instances, based on a date on which the current transaction occurred. In some implementations, the prediction engine 162 generates the category interaction abnormality score based on a corresponding portion of the anomaly scoring algorithm, such as the global category interaction feature described above. For example, given the user category abnormality score generated for the particular user's transaction (the “current transaction”), the prediction engine 162 may generate the category interaction abnormality score based on identifying one or more global sets of same-category transactions (e.g., among all users) that were assigned the same category as the current transaction, determining a global central tendency of variability associated with the global sets of same-category transactions, and generating the category interaction abnormality score based on a difference between the global central tendency of variability and a current measure of variability associated with the user category abnormality score generated for the particular user's transaction (the “current transaction”).

In generating the category interaction abnormality score, the prediction engine 162 may determine the measures of variability, the central tendency of variability, and/or the current measure of variability in real-time, or to conserve processing and memory resources, the prediction engine 162 may retrieve the measures of variability, central tendency of variability, and/or current measure of variability from one or more databases, such as if said values were predetermined by one or more other appropriate components. In some instances, the measures of variability are determined globally across users based on the standard deviations between final amounts stored and the users' corresponding centrality points (e.g., averages) for transactions assigned the same category. In some instances, the central tendency of variability is determined based on an average of the measures of variability determined globally across users. In some instances, the current measure of variability is determined based on a number of standard deviations between the original amount entered by the particular user and the centrality point (e.g., average) of final amounts determined for the particular user, such as like described above with respect to the user category abnormality score. In these and other manners, the prediction engine 162 can generate the category interaction abnormality score for the current transaction based on a difference between the current measure of variability (e.g., associated with the user category abnormality score generated for the user based on the per-user category abnormality feature) and the central tendency of variability (e.g., associated with a tendency of variability among category interaction abnormality scores generated across users globally).

In some instances, the prediction engine 162 may generate the category interaction abnormality score further based on a date on which the current transaction occurred, such as if the anomaly scoring algorithm incorporates one or more global category interaction weights that increase or decrease the category interaction abnormality score based on whether the current transaction occurred before or after a particular date, during a particular range of dates, and/or within a particular pattern deemed relevant to the given category and user. As a non-limiting example, a global category interaction weight may decrease the category interaction abnormality score for a given transaction (i.e., decrease a determined abnormality of the original amount entered for the given transaction) if the transaction is assigned a “travel” category and occurred during a time period associated with a relatively high central tendency of variability among user category abnormality scores generated for transactions of the “travel” category across users globally, such as during a time period associated with a global pandemic and a relatively high number of users being in quarantine. It is to be understood that the prediction engine 162 may use any other appropriate combination of statistical measures or patterns incorporated into the anomaly scoring algorithm to determine a relative abnormality of a user category abnormality score generated for a transaction based on user category abnormality scores generated for other users' transactions that were assigned the same category as the current transaction, and in some instances, further based on a date on which the current transaction occurred.

As another non-limiting example of an interaction feature value, the prediction engine 162 may be used to generate an industry interaction abnormality score for the original amount entered for the current transaction suggesting a probability of the industry abnormality score being generated for the current transaction (such as for the transaction associated with the industry abnormality score described above) based on industry abnormality scores generated for transactions associated with users operating in the same industry, and in some instances, based on a date on which the current transaction occurred. In some implementations, the prediction engine 162 generates the industry interaction abnormality score based on a corresponding portion of the anomaly scoring algorithm, such as the global industry interaction feature described above. For example, given the industry abnormality score generated for the particular user's transaction (the “current transaction”), the prediction engine 162 may generate the industry interaction abnormality score based on identifying one or more global sets of same-industry transactions (e.g., across all users) associated with users operating in a same industry as the particular user, determining a global central tendency of variability associated with the global sets of same-industry transactions, and generating the industry interaction abnormality score based on a difference between the global central tendency of variability and a current measure of variability associated with the industry abnormality score generated for the particular user's transaction (the “current transaction”).

In generating the industry interaction abnormality score, the prediction engine 162 may determine the measures of variability, the central tendency of variability, and/or the current measure of variability in real-time, or to conserve processing and memory resources, the prediction engine 162 may retrieve the measures of variability, central tendency of variability, and/or current measure of variability from one or more databases, such as if said values were predetermined by one or more other appropriate components. In some instances, the measures of variability are determined globally across users based on the standard deviations between final amounts stored and the users' corresponding centrality points (e.g., averages) for transactions associated with users operating in the same industry. In some instances, the central tendency of variability is determined based on an average of the measures of variability determined globally across users. In some instances, the current measure of variability is determined based on a number of standard deviations between the original amount entered by the particular user and the centrality point (e.g., average) of final amounts determined for the particular user, such as like described above with respect to the industry abnormality score. In these and other manners, the prediction engine 162 can generate the industry interaction abnormality score for the current transaction based on a difference between the current measure of variability (e.g., associated with the industry abnormality score generated for the user based on the per-user industry abnormality feature) and the central tendency of variability (e.g., associated with a tendency of variability among industry interaction abnormality scores generated across users globally).

In some instances, the prediction engine 162 may generate the industry interaction abnormality score further based on a date on which the current transaction occurred, such as if the anomaly scoring algorithm incorporates one or more global industry interaction weights that increase or decrease the industry interaction abnormality score based on whether the current transaction occurred before or after a particular date, during a particular range of dates, and/or within a particular pattern deemed relevant to the given industry and user. The prediction engine 162 may use any appropriate combination of statistical measures or patterns incorporated into the anomaly scoring algorithm to determine a relative abnormality of an industry abnormality score generated for a transaction based on industry abnormality scores generated for transactions associated with other users operating in the same industry as the user associated with the current transaction, and in some instances, further based on a date on which the current transaction occurred.

As another non-limiting example of an interaction feature value, the prediction engine 162 may be used to generate a type interaction abnormality score for the original amount entered for the current transaction suggesting a probability of the type abnormality score being generated for the current transaction (such as for the transaction associated with the type abnormality score described above) based on type abnormality scores generated for transactions of the same type, and in some instances, based on a date on which the current transaction occurred. In some implementations, the prediction engine 162 generates the type interaction abnormality score based on a corresponding portion of the anomaly scoring algorithm, such as the global type interaction feature described above. For example, given the type abnormality score generated for the particular user's transaction (the “current transaction”), the prediction engine 162 may generate the type interaction abnormality score based on identifying one or more global sets of same-type transactions (e.g., among all users) of the same type as the current transaction, determining a global central tendency of variability associated with the global sets of same-type transactions, and generating the type interaction abnormality score based on a difference between the global central tendency of variability and a current measure of variability associated with the type abnormality score generated for the particular user's transaction (the “current transaction”).

In generating the type interaction abnormality score, the prediction engine 162 may determine the measures of variability, the central tendency of variability, and/or the current measure of variability in real-time, or to conserve processing and memory resources, the prediction engine 162 may retrieve the measures of variability, central tendency of variability, and/or current measure of variability from one or more databases, such as if said values were predetermined by one or more other appropriate components. In some instances, the measures of variability are determined globally across users based on the standard deviations between final amounts stored and the users' corresponding centrality points (e.g., averages) for transactions of the same type. In some instances, the central tendency of variability is determined based on an average of the measures of variability determined globally across users. In some instances, the current measure of variability is determined based on a number of standard deviations between the original amount entered by the particular user and the centrality point (e.g., average) of final amounts determined for the particular user, such as like described above with respect to the type abnormality score. In these and other manners, the prediction engine 162 can generate the type interaction abnormality score for the current transaction based on a difference between the current measure of variability (e.g., associated with the type abnormality score generated for the user based on the per-user type abnormality feature) and the central tendency of variability (e.g., associated with a tendency of variability among type interaction abnormality scores generated across users globally).

In some instances, the prediction engine 162 may generate the type interaction abnormality score further based on a date on which the current transaction occurred, such as if the anomaly scoring algorithm incorporates one or more global type interaction weights that increase or decrease the type interaction abnormality score based on whether the current transaction occurred before or after a particular date, during a particular range of dates, and/or within a particular pattern deemed relevant to the given transaction type. The prediction engine 162 may use any appropriate combination of statistical measures or patterns incorporated into the anomaly scoring algorithm to determine a relative abnormality of a type abnormality score generated for a transaction based on type abnormality scores generated for other transactions of the same type as the current transaction, and in some instances, further based on a date on which the current transaction occurred.

The prediction engine 162 may also be used to predict a likelihood that the original amount entered for the current transaction will be changed. In some implementations, the prediction engine 162 may generate the predicted likelihood using a trained predictive model (e.g., the predictive model 154) in conjunction with an anomaly scoring algorithm generated using a machine learning process. In some aspects, the predicted likelihood is based on the overall abnormality score (e.g., such as based on a concatenation of the values generated for the predictive and interactive features incorporated into a given implementation), which the prediction engine 162 may generate based on a combination of at least one of the predictive features and interaction features. For example, the overall abnormality score may be based on a combination of at least one of the type abnormality score, the industry abnormality score, the user category abnormality score, the category interaction abnormality score, the industry interaction abnormality score, the type interaction abnormality score, or another appropriate abnormality score defined based on transaction and/or user attributes. In these and other manners, the prediction engine 162 may determine a relative abnormality of the original amount based on a type of the current transaction, a category assigned to the current transaction, a user associated with the current transaction, an industry in which the associated user operates, and/or a date on which the current transaction occurred. In some implementations, the prediction engine 162 may provide the predicted likelihood to the classification engine 184 for further processing.

The classification engine 184 may be used to classify the original amount as normal or anomalous, such as based on the predicted likelihood that the original amount entered for the current transaction will be changed. For example, if the predicted likelihood is greater than a specified value (e.g., 0.5, or another appropriate value), the classification engine 184 may classify the original amount as “anomalous,” and if the predicted likelihood is less-than-or-equal to the specified value, the classification engine 184 may classify the original amount as “normal.” In response to classifying the original amount as normal, the classification engine 184 may refrain from providing the classified transaction to the action engine 188. Otherwise, in response to classifying the original amount as anomalous, the classification engine 184 may provide the classified transaction to the action engine 188 for further processing.

The action engine 188 may be used to perform one or more selective actions in response to the original amount being classified as “anomalous.” In some implementations, the action engine 188 flags the anomalous amount, such as by storing metadata for the corresponding transaction indicating that the original amount was classified as anomalous. In addition, or in the alternative, the action engine 188 generates and/or provides a notification regarding the anomalous transaction, such as by presenting (e.g., via the interface 110) a notification to the user that entered the original amount indicating that the original amount entered may be an error or is likely inaccurate. In addition, or in the alternative, the action engine 188 generates and/or provides a proposed value to replace the original amount, such as by suggesting (e.g., via the interface 110) an expected amount or an expected range of amounts that the classification engine 184 in conjunction with the predictive model 154 would classify as “normal.” In addition, or in the alternative, the action engine 188 generates and/or provides a request for a replacement value, such as by requesting (e.g., via the interface 110) that the user enter a new amount to replace the original amount.

The action engine 188 may also be used to determine whether a final amount stored (after some period of time) for the current transaction is different than the original amount. In some implementations, the action engine 188 may annotate the current transaction based on the determination and the classification provided by the classification engine 184. As an example, the action engine 188 may annotate the current transaction as a “false-negative” if the original amount is classified as “normal” (e.g., not abnormal beyond a threshold) and the final amount is different than the original amount (e.g., the original amount entered is actually likely to have been an error). As another example, the action engine 188 may annotate the current transaction as a “false-positive” if the original amount is classified as “anomalous” (e.g., abnormal (or “unexpected”) beyond a threshold) and the final amount is the same as the original amount (e.g., the original amount entered is actually likely not to have been an error). As another example, the action engine 188 may annotate the current transaction as a “true-negative” if the original amount is classified as “normal” (e.g., not abnormal beyond a threshold) and the final amount is the same as the original amount (e.g., the original amount entered is indeed likely not to have been an error). As another example, the action engine 188 may annotate the current transaction as a “true-positive” if the original amount is classified as “anomalous” (e.g., abnormal beyond a threshold) and the final amount is different than the original amount (e.g., the original amount entered is indeed likely to have been an error). In some implementations, the action engine 188 may provide the annotated transactions to one or more other appropriate components for further processing. For example, the action engine 188 may provide the annotated transactions to a training engine (such as the training engine 150) and/or an adaptation engine (such as the adaptation engine 158) such that the training engine and/or the adaptation engine may use the annotated transactions in conjunction with a machine learning process to train a predictive model (such as the predictive model 154) to more accurately predict whether an amount originally entered for a given transaction will be changed using an anomaly scoring algorithm augmented based on the annotated transactions.

In these and other manners, the system 100 may be used to validate a transaction amount—that is, one or more of the detection engine 160, the prediction engine 162, the classification engine 184, and the action engine 188, may be used to classify an original amount entered for a transaction as normal or anomalous based on predicting, using a trained predictive model, a likelihood that the original amount will be changed.

The acquisition engine 140, the characterization engine 148, the training engine 150, the adaptation engine 158, the detection engine 160, the prediction engine 162, the classification engine 184, and/or the action engine 188 may be implemented in software, hardware, or a combination thereof. In some implementations, any one or more of the acquisition engine 140, characterization engine 148, training engine 150, adaptation engine 158, detection engine 160, prediction engine 162, classification engine 184, or the action engine 188 may be embodied in instructions that, when executed by the processor 130, cause the system 100 to perform operations. The instructions of one or more of said engines and/or one or more of the transactions database 122 or the user database 124, may be stored in the memory 132, the database 120, or a different suitable memory. The instructions may be in any suitable programming language format for execution by the system 100, such as by the processor 130. It is to be understood that the particular architecture of the system 100 shown in FIG. 1 is but one example of a variety of different architectures within which aspects of the present disclosure may be implemented. For example, in some other implementations, components of the system 100 may be distributed across multiple devices, included in fewer components, and so on. While the below examples of training a predictive model to validate a transaction amount and/or validating a transaction amount in real-time are described with reference to the system 100, other suitable system configurations may be used.

FIG. 2 shows a high-level overview of an example process flow 200 that may be employed by a validation system, according to some implementations, during which the characterization engine 148 in conjunction with at least the training engine 150 trains a predictive model (e.g., the predictive model 154) to validate a transaction amount. The validation system may be and/or incorporate one or more (including all) aspects described with respect to the system 100 shown in FIG. 1. In some other implementations, the validation system described with respect to FIG. 2 may not incorporate one or more aspects described with respect to the system 100 shown in FIG. 1, such as, in some implementations, the detection engine 160, the prediction engine 162, the classification engine 184, and/or the action engine 188, and in one or more implementations, one or more of the acquisition engine 140 or the adaptation engine 158.

At block 210, at least one of the acquisition engine 140 or the characterization engine 148 retrieves historical data indicating a number of attributes for each of a plurality of transactions stored in one or more of the database 120, the transactions database 122, the user database 124, or another appropriate data store. In some implementations, the attributes indicate, for each transaction, one or more of a date that the transaction occurred, a user associated with the transaction, a type of the transaction, a category assigned to the transaction, an original amount entered for the transaction, and a final amount stored for the transaction. In some other implementations, one or more of the plurality of transactions are prelabeled, and in such implementations, the attributes associated with the prelabeled transactions may not include an original amount entered for the prelabeled transaction and/or a final amount stored for the prelabeled transaction.

At block 220, the characterization engine 148 assigns a label to each unlabeled transaction of the plurality of transactions based on whether the original amount entered for the unlabeled transaction was changed. In some implementations, the characterization engine 148 labels the unlabeled transactions based on a comparison of the original amount entered for the unlabeled transaction and the final amount stored for the unlabeled transaction. In some other implementations, one or more of the plurality of transactions are prelabeled, and in such implementations, the characterization engine 148 may refrain from assigning labels to the prelabeled transactions.

At block 230, the characterization engine 148 defines a number of predictive features based on the attributes. In some implementations, the predictive features suggest an extent to which final amounts stored for a particular set of similar transactions tend to vary, such as transactions that have (or “share”) a same value for one or more of the attributes, such as the date the transactions occurred, the user associated with the transactions, the type of the transactions, the category assigned to the transactions, and/or any other appropriate attribute that the transactions may share. Non-limiting examples of predictive features that the characterization engine 148 may define include at least one of a type abnormality feature, an industry abnormality feature, or a per-user category abnormality feature, such as described with respect to FIG. 1.

At block 240, the characterization engine 148 defines one or more interaction features based on the predictive features. In some implementations, the interaction features suggest a probability of a given predictive feature value being generated for a given transaction based on its attributes or other characteristics. Non-limiting examples of interaction features that the characterization engine 148 may define include at least a global category interaction feature, a global industry interaction feature, or a global type interaction feature, such as described with respect to FIG. 1.

At block 250, the training engine 150 uses a machine learning process to generate an anomaly scoring algorithm based on the predictive features and the one or more interaction features. In some implementations, the anomaly scoring algorithm incorporates at least one of the type abnormality, industry abnormality, user category abnormality, global category interaction feature, global industry interaction feature, or global type interaction feature.

At block 260, the training engine 150 trains a predictive model (e.g., the predictive model 154) to generate a predicted likelihood that the transaction amount is an anomaly, such as based on the attributes—that is, the trained predictive model 154 may be used to predict, using the anomaly scoring algorithm, whether an original amount entered for a given transaction will be changed.

In some implementations, after block 260, the adaptation engine 158 may determine an accuracy at which the predictive model 154 can determine whether an amount originally entered for a given transaction was changed (e.g., likely to have been an error). In some implementations, the adaptation engine 158 may use validation data to determine the accuracy, as further described in connection with FIG. 1. In some other implementations, the adaptation engine 158 may recursively and/or iteratively validate and train the predictive model until its accuracy is greater than a threshold.

FIG. 3 shows a high-level overview of an example process flow 300 that may be employed by a validation system, according to some implementations, during which the prediction engine 162 in conjunction with at least the classification engine 184 validates a transaction amount, such as by using a trained predictive model. The validation system may be and/or incorporate one or more (including all) aspects described with respect to the system 100 shown in FIG. 1. In some other implementations, the validation system described with respect to FIG. 3 may not incorporate one or more aspects described with respect to the system 100 shown in FIG. 1, such as, in some implementations, the acquisition engine 140, the characterization engine 148, the training engine 150, and/or the adaptation engine 158, and in one or more implementations, one or more of the detection engine 160 or the action engine 188.

In some implementations, prior to block 310, the detection engine 160 may detect a transaction amount, such as an original amount of a current transaction being entered in real-time (such as by a user via a user interface), and/or may retrieve a number of attributes associated with the current transaction and/or the user, such as from one or more of the databases.

At block 310, the prediction engine 162 generates a number of predictive feature values for the current transaction, such as based on the attributes. In some implementations, the feature values suggest a probability of the original amount being entered for the current transaction. In some implementations not shown, the feature values contribute to an overall abnormality score suggesting a relative likelihood that the original amount is an anomaly (e.g., will be changed). Non-limiting examples of predictive features that the prediction engine 162 may generate include at least one of a type abnormality score, an industry abnormality score, or a user category abnormality score, such as described with respect to FIG. 1.

At block 320, the prediction engine 162 generates one or more interaction feature values for the current transaction, such as based on one of the number of predictive feature values. In some implementations, the one or more interaction feature values suggest a probability of at least one of the feature values being generated given the attributes of the current transaction. In some implementations not shown, the one or more interaction feature values further contribute to the overall abnormality score for the current transaction. Non-limiting examples of interaction features that the prediction engine 162 may generate include at least one of a type interaction abnormality score, an industry interaction abnormality score, or a category interaction abnormality score, such as described with respect to FIG. 1.

At block 330, the prediction engine 162 predicts a likelihood that the original amount entered for the current transaction will be changed based on the feature values and the one or more interaction feature values. In some implementations, the prediction engine 162 predicts the likelihood using a predictive model and an anomaly scoring algorithm. In some aspects, the anomaly scoring algorithm is generated using a machine learning process, and the predicted likelihood is based on the overall abnormality score generated based on a combination of at least one of the type abnormality score, the industry abnormality score, the user category abnormality score, the category interaction abnormality score, the industry interaction abnormality score, the type interaction abnormality score, or another appropriate abnormality score not shown.

At block 340, the classification engine 184 classifies the original amount as normal or anomalous, such as by comparing the predicted likelihood with a specified value. In some implementations, the classification engine 184 may refrain from further processing transactions classified as normal.

In some implementations, after block 340, the action engine 188 may perform one or more selective actions, such as if the original amount is classified as anomalous. Non-limiting examples of actions that the action engine 188 may perform include flagging the transaction, generating a notification that the transaction was classified as an anomaly, generating a proposed replacement value for the original amount, generating a request for a replacement amount, or another appropriate action performed in response to the original amount being classified as normal or anomalous. In some implementations not shown, the action engine 188 may also annotate the current transaction based on a comparison of the classification provided by the classification engine 184 and an actual result determined based on a final amount stored for the current transaction, and/or provide the current transaction to one or more other components for further processing, such as further training and/or validating the predictive model.

FIG. 4 shows a high-level overview of an example process flow 400 that may be employed by the system 100 of FIG. 1 and/or the validation system described with respect to FIG. 2, according to some implementations, during which the characterization engine 148 in conjunction with at least the training engine 150 trains the predictive model 154 to validate a transaction amount.

At block 410, the characterization engine 148 may retrieve historical data indicating a number of attributes for each respective transaction of a plurality of transactions.

At block 420, the characterization engine 148 may assign a label to each respective transaction of the plurality of transactions based on whether an original amount entered for the respective transaction was changed.

At block 430, the characterization engine 148 may define a number of predictive features based on the attributes, the predictive features suggesting an extent to which final amounts stored for a particular set of similar transactions tend to vary.

At block 440, the characterization engine 148 may define one or more interaction features based on the predictive features, the one or more interaction features suggesting a probability of a particular predictive feature value being generated for a transaction having particular attributes.

At block 450, the training engine 150 may generate, using a machine learning process, an anomaly scoring algorithm based on the predictive features and the one or more interaction features.

At block 460, the training engine 150 may train, using the labeled transactions, a predictive model to predict, using the anomaly scoring algorithm, whether an amount originally entered for a given transaction will be changed.

FIG. 5 shows a high-level overview of an example process flow 500 that may be employed by the system 100 of FIG. 1 and/or the validation system described with respect to FIG. 3, according to some implementations, during which the prediction engine 162 in conjunction with at least the classification engine 184 validates a transaction amount.

At block 510, the prediction engine 162 may generate a number of feature values for a current transaction, the feature values suggesting a probability of an original amount being entered for the current transaction based on attributes of the current transaction.

At block 520, the prediction engine 162 may generate one or more interaction feature values for the current transaction, the one or more interaction feature values suggesting a probability of at least one of the feature values being generated given the current transaction's attributes.

At block 530, the prediction engine 162 may predict, using a predictive model and an anomaly scoring algorithm generated using a machine learning process, a likelihood that the original amount entered for the current transaction will be changed based on the feature values and the one or more interaction feature values.

At block 540, the classification engine 184 may classify the original amount as normal or anomalous based on the predicted likelihood.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other suitable configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure and the principles and novel features disclosed herein.

1. A method for training a predictive model to validate a transaction amount, the method performed by one or more processors of a validation system and comprising:
retrieving, from memory using the one or more processors, historical data indicating a number of attributes for each respective transaction of a plurality of transactions;
assigning a label to each respective transaction of the plurality of transactions based on whether an original amount entered via an interface for the respective transaction was changed;
defining a number of predictive features based on the attributes, the predictive features indicating an extent to which final amounts stored for a particular set of similar transactions tend to vary;
defining one or more interaction features based on the predictive features, the one or more interaction features predicting a probability of a particular predictive feature value being generated for a transaction having particular attributes;
generating, using a machine learning process in conjunction with instructions executed by the one or more processors, an anomaly scoring algorithm executed by the one or more processors based on the predictive features and the one or more interaction features;
training, using the labeled transactions, a predictive model to predict, using the anomaly scoring algorithm executed by the one or more processors, whether an amount originally entered for a given transaction will be changed; and
iteratively training the trained predictive model until an accuracy at which the trained predictive model can predict, using the anomaly scoring algorithm executed by the one or more processors, whether the amount entered for the given transaction will be changed is greater than a value.

2. The method of claim 1, wherein assigning a first label to the respective transaction indicates that the original amount entered for the respective transaction is the same as the final amount stored for the respective transaction, and wherein assigning a second label to the respective transaction indicates that the original amount entered for the respective transaction is different than the final amount stored for the respective transaction.

3. The method of claim 1, wherein the plurality of transactions are retrieved from a transactions database, wherein each respective transaction is associated with one of a plurality of transaction types, one of a plurality of categories, and one of a plurality of users, wherein each of the plurality of users operates in one of a plurality of industries, and wherein the attributes include at least a first attribute indicating a date that the respective transaction occurred, a second attribute identifying a user associated with the respective transaction, a third attribute indicating a type of the respective transaction, a fourth attribute indicating a category assigned to the respective transaction, a fifth attribute indicating an original amount entered for the respective transaction, and a sixth attribute indicating a final amount stored for the respective transaction.

4. The method of claim 1, wherein each respective transaction is associated with one of a plurality of transaction types, wherein the attributes indicate at least a date that the respective transaction occurred, a transaction type of the respective transaction, an original amount entered for the respective transaction, and a final amount stored for the respective transaction, wherein the predictive features include at least a type abnormality feature indicating an extent to which final amounts stored for transactions of a specified transaction type tend to vary during a specified time period, and wherein defining the type abnormality feature includes:
grouping the plurality of transactions into sets of same-type transactions based on the historical data, wherein each transaction of each set of same-type transactions occurred during a same time period and is of a same transaction type;
determining a centrality point of the final amounts stored for each set of same-type transactions;
determining, for each set of same-type transactions, a measure of variability between the centrality point and each final amount stored for the corresponding set of same-type transactions; and
determining, based on the corresponding measures of variability, a central tendency of variability among the final amounts stored for each set of same-type transactions, wherein determining the central tendency of variability includes selectively applying a number of type seasonality weights to the corresponding measures of variability based on whether the associated transaction occurred before or after a particular date, during a particular range of dates, or within a particular pattern deemed relevant to the corresponding transaction type.

5. The method of claim 1, wherein each respective transaction is associated with one of a plurality of users, wherein each of the plurality of users operates in one of a plurality of industries, and wherein the attributes indicate at least a date that the respective transaction occurred, a user associated with the respective transaction, an original amount entered for the respective transaction, and a final amount stored for the respective transaction, wherein the predictive features include at least an industry abnormality feature indicating an extent to which final amounts stored for transactions associated with users operating in a specified industry tend to vary during a specified time period, and wherein defining the industry abnormality feature includes:
grouping the plurality of transactions into sets of same-industry transactions based on the historical data, wherein each transaction of each set of same-industry transactions occurred during a same time period and is associated with a user operating in a same industry;
determining a centrality point of the final amounts stored for each set of same-industry transactions;
determining, for each set of same-industry transactions, a measure of variability between the centrality point and each final amount stored for the corresponding set of same-industry transactions; and
determining, based on the corresponding measures of variability, a central tendency of variability among the final amounts stored for each set of same-industry transactions, wherein determining the central tendency of variability includes selectively applying a number of industry seasonality weights to the corresponding measures of variability based on whether the associated transaction occurred before or after a particular date, during a particular range of dates, or within a particular pattern deemed relevant to the corresponding industry.

6. The method of claim 1, wherein each respective transaction is associated with one of a plurality of categories and one of a plurality of users, and wherein the attributes indicate at least a date that the respective transaction occurred, a user associated with the respective transaction, a category assigned to the respective transaction, an original amount entered for the respective transaction, and a final amount stored for the respective transaction, wherein the predictive features include at least a per-user category abnormality feature indicating, for each respective user, an extent to which final amounts stored for transactions assigned a specified category tend to vary for the respective user during a specified time period, and wherein defining the per-user category abnormality feature includes:
grouping, for each respective user, the plurality of transactions into sets of same-category transactions based on the historical data, wherein each transaction of each set of same-category transactions is associated with a same respective user, occurred during a same time period, and is assigned a same category;
determining, for each respective same user, a centrality point of the final amounts stored for each set of same-category transactions associated with the respective same user;
determining, for each set of same-category transactions, a measure of variability between the centrality point and each final amount stored for the corresponding set of same-category transactions; and
determining, based on the corresponding measures of variability and for each respective same user, a central tendency of variability among the final amounts stored for each set of same-category transactions associated with the respective same user, wherein determining the central tendency of variability includes selectively applying a number of user seasonality weights to the corresponding measures of variability based on whether the associated transaction occurred before or after a particular date, during a particular range of dates, or within a particular pattern deemed relevant to transactions associated with the respective same user and the respective same category.

7. The method of claim 6, wherein the one or more interaction features include at least a global category interaction feature predicting a probability of a category abnormality feature value being generated for a transaction associated with a given user, occurring on a given date, and assigned a given category.

8. The method of claim 1, wherein the anomaly scoring algorithm incorporates at least one of a type abnormality feature indicating an extent to which final amounts stored for transactions of a specified transaction type tend to vary over time, an industry abnormality feature indicating an extent to which final amounts stored for transactions associated with users operating in a specified industry tend to vary over time, a user category abnormality feature indicating, for each respective user of a plurality of users, an extent to which final amounts stored for transactions assigned a specified category tend to vary over time for the respective user, and a global category interaction feature indicating, for each respective user, an extent to which the user category abnormality feature tends to vary over time for transactions associated with the respective user and assigned a given category.

9. The method of claim 1, wherein the iterative training includes at least:
determining, using validation data associated with prelabeled transactions, an accuracy at which the predictive model can determine whether amounts originally entered for the prelabeled transactions were changed;
training, using additional historical data associated with additional transactions, the predictive model to more accurately predict, using the anomaly scoring algorithm, whether an amount originally entered for a given transaction will be changed; and
iteratively validating and training the predictive model until the determined accuracy is greater than a value.

10. A system for training a predictive model to validate a transaction amount, the system comprising:
one or more processors; and
at least one memory coupled to the one or more processors and storing instructions that, when executed by the one or more processors, cause the system to perform operations including:
retrieving, from memory using the one or more processors, historical data indicating a number of attributes for each respective transaction of a plurality of transactions;
assigning a label to each respective transaction of the plurality of transactions based on whether an original amount entered via an interface for the respective transaction was changed;
defining a number of predictive features based on the attributes, the predictive features indicating an extent to which final amounts stored for a particular set of similar transactions tend to vary;
defining one or more interaction features based on the predictive features, the one or more interaction features predicting a probability of a particular predictive feature value being generated for a transaction having particular attributes;
generating, using a machine learning process in conjunction with instructions executed by the one or more processors, an anomaly scoring algorithm executed by the one or more processors based on the predictive features and the one or more interaction features;
training, using the labeled transactions, a predictive model to predict, using the anomaly scoring algorithm executed by the one or more processors, whether an amount originally entered for a given transaction will be changed; and
iteratively training the trained predictive model until an accuracy at which the trained predictive model can predict, using the anomaly scoring algorithm executed by the one or more processors, whether the amount entered for the given transaction will be changed is greater than a value.

11-20. (canceled)
